(19) United States
(12) Patent Application Publication
(10) Pub. No.: US 2020/0248988 A1
(43) Pub. Date: Aug. 6, 2020

(54) METHODS, SYSTEMS, AND APPARATUS FOR MULTI-USE MULTI-VISION MODULAR INVISIBLE COVERS

(71) Applicant: Alejandro Evaristo Perez, Dallas, TX (US)

(72) Inventor: Alejandro Evaristo Perez, Dallas, TX (US)

(73) Assignee: Alejandro Evaristo Perez, Dallas, TX (US)

(21) Appl. No.: 16/267,385

(22) Filed: Feb. 5, 2019

(51) Int. Cl. F41H 3/02; G06F 1/16

(52) U.S. Cl. CPC F41H 3/02; G06F 1/163

(57) ABSTRACT

In accordance with one embodiment of the present invention, a method of multi-use multi-vision modular covers comprising of aggregating multiple devices into physical meshes and virtual networks where devices exchange multi-source data transactions and transmissions between meshed devices to project on their respective screens the exchanged images, videos, and/or visual adjustments to produce multiple video “See Through” streams between meshed devices in static states and/or in motion. In a preferred embodiment, the invention is combination of devices, cameras, and/or screens that produce “See-Through” video streams with enhancements to hide, protect, and sustain modular permutations of invisible armors, invisible cloaks, invisible vehicles, invisible crafts, invisible land drones, invisible flying drones, invisible camo nettings, and other invisible configurations managed by manager-of-manager portal platforms that can provision, manage, and monitor all these configurations and deployments during a battle while producing synergies of invisible combined arms tactics to defeat the enemies of God.

### TECHNICAL FIELD

The present application generally relates to facilitating the creation process of multi-use multi-vision modular invisible covers and efficiently managing configurations and reconfigurations by aggregating multiple displays, cameras, and devices into physical meshes and virtual networks where devices exchange data transactions from multiple sources and transmissions between meshed devices to project on their respective screens the exchanged images and/or visual adjustments to produce multiple video stream “See-Through” effects between meshed devices. A computer-implemented data exchanging methods produce and sustain the modular invisible covers within the configurations and deployment to adjust and readjust the “See-Though” video streams in static states and in motion, and whereas the data provided by the devices are selected and distributed within and across configurations and deployments consisting of standard IT protocols, multiple transmissions, routing protocols, geo-location tables, proximity tables, temperature tables, rule algorithms, pixelation charts, preset filters, error correction controls, workflow functionality, trigger mechanisms, personalized settings, user directories, command settings, and/or an associated meta tags in one or more device; one or more remote server environments; and/or a modern P2P network. Certain aspects of the invention present a novel solution convert invisible covers into invisible armors with the use of alloys and non-alloys for protection. Other combinations of the invention can create further invisibility and stealth by neutralizing Thermal Signals, Light Emission, X-ray signals, and mute noises per configuration when enhanced with a variety of Air Conditioning mechanisms, Light Emission controls, high-density lead alloys, and active noise controls. Certain aspects of the invention present a novel solution to manage, facilitate, transact, and enable a range of configurations and implementation from invisible cloaking for an individual to hiding large crafts to using larger multi-network covers to hide cities. Other aspects contemplate the usage of e-wearables and positioning techniques, such as triangulation and geofencing. Other aspects contemplate using drone flight technology on the devices to deploy local invisible drone scouts from a meshed device configuration, while scaling the invention can create larger interdepended complex flying drone formations of multiple invisible defensive walls in order to protect and hide military elements.

### BACKGROUND

The present application acknowledges the existence of other invisibility attempts and quasi-invisible methods, such as the Invisible Cloak (Patent Application DE 202011104126U), three-dimensional sound invisible cloak structure (Patent Application CN 201410617598), Circuit-loaded conformal metasurface cloak (Patent Application US 20160087342A1), Wave absorbing metamaterial and device (Patent Application CN 102843899A), Three-dimensional fully-polarized super-surface invisible cloak (Patent Application CN 105823378A), Unidirectional device dimensional ellipse stealth (Patent Application CN 105655718B), and HE, XIAO: “Design and Validation of the Electromagnetic Invisibility Cloaks”, HARBIN INSTITUTE OF TECHNOLOGY, 6 Jan. 2011. However, none of the above methods, ideas, and intellectual property focuses on exchange videos streaming between devices to create “See Thought” effects by trading polar-opposite video images to be shown in the displays, which makes the Invisible Modular Armor Types superior to these prior methods in both novelty, practicality, and scope. And when the prior-art intellectual property does show practical applications, the prior art materializes in pseudo-quasi-invisibility by poorly manipulating electromagnetic sciences to hide and disrupt electronic transitions while attempting to bending light for distort images rather than creating any invisibility effects with the use of exchanging video streaming. A simple invisibility case is two commercial iPhone smartphone devices with FaceTime application installed can create a simple “See-Through” effect by making a Video Call and placing those two devices on a person and then polar-facing those devices as shown in the FIGURES within this invention. No need for the quasi-science of the artificial metamaterial. No need for quasi-science of dielectric tensor distributors. No need for fancy LED light bulbs. No need for the quasi-science of fourth quadrant coordination. No for prestress impedance conversance layers. No need for the odd science of damping material fills. No need for the quasi-science of electromagnetic leakage. Invisibility can be achieved with video stream exchanges and placed in the correct method can create invisibility without killing the user carrying a blanket of highly charged electrical wires. Their prior-art intellectual properties are hypothetical cases with mathematical equations towards the electromagnetism rather than a practical application of invisibility, such as actually hiding a person from the human eye or hiding a soldier from night vision detection. These problems in the prior art methods are easy to identify, because the above prior art does not mention the words ‘Data’, ‘Video’, ‘Steaming’, ‘Night Vision’, nor in any combination nor many words that match with the novelty and scope of Multi-Use Multi-Vision Modular Invisible Covers, except of the words “Invisibility”, “User”, and “Cloak”. This invention disrupts all prior art regarding invisibility.

U.S. Pat. No. 9,971,162 B2/U.S. Ser. No. 10/161,720 Apparatus and Methods for Making an Object Appear Transparent, and U.S. Pat. No. 9,405,118 Optical Cloaking System focus on creating invisibility using mirrors or for mirrors to bend light. These inventions are unrelated to multiple video streams for a plurality of smart devices. These inventions and their derivatives are fixed and specific to mirrors and lenses, instead of modular and mobile meshes of smart devices, displays, nor cameras.

Public Domain shows several individuals, like Mark Rober, a NASA scientist, playing with 2 iPads and other engineers using 2 iPads or 2 iPhones to create a one-to-one ‘See-Though’ effect. The articles are “That's one way to blow $1,000! Rocket scientist hooks up two iPads so you can ‘see’ right through him for Halloween” and “Watch the incredible ‘iPad invisibility cloak’ in action: New technique can make objects disappear using a tablet and a camera”. The articles mention the Rochester Cloak and the ‘perfect paraxial’ cloak used by Dr. Joseph Choi that uses lenses and mirrors to create the illusion of invisibility as mentioned earlier, which it is not video streams nor smart devices. Overall, these individuals and corporations they represent in the articles failed to file a patent nor created invisible personal body armors nor invisible modular cloak to endure the hardships and requirements of warfare. Mark Rober, a NASA rocket scientist, instead made a civilian Halloween costume for personal entertainment to simulate a large hole in his torso as if he, himself, was shot by a large cannon. In the end, the static 2 iPads performing “See-Through” fails to be an invisible body armor nor a light invisibility cloak that handles motion, no different than four rubber tires on the floor is a vehicle. The Halloween costume cannot stop 9 mm bullets, 5.56 NATO, nor 7.62 mm rounds nor does the costume hide his whole body. These articles fail to mention invisible personal body armors using video streams from modular smart devices or custom smart devices with alloys and other features for protecting and hiding soldiers from the horrors of war with practical, reliable, scalable, and systematic invisibility methods. Nor do the articles mention thermal neutralizing, X-ray neutralizing, night vision involved, nor multiple redundant video streams (ex. Wi-Fi, Bluetooth, Ethernet-connected, USB-connected, telecom) per device. Nothing about daisy chain video streams. Nothing about multiple “See-Through” videos stream sessions to replace another “See-Through” videos stream upon failing (ex. damage, explosions, interference). Nothing about combining shared video streams to improve or create a new video stream. Nothing about a management-of-management software to provision and onboard users, devices, and configurations. Nothing about Active Noise Controls to become auditory stealth. These individuals are just toying with the concept of using a video stream to create invisibility without any real-world applications like person rolling rubber tires down a hill and dreaming of a vehicle. Hence why Mark Rober, the NASA rocket scientist, create a cheap Halloween costume with 2 iPads. In the end, basic flaw of the two static iPad system can be seen when those very iPads are placed on the opposite side of the legs and the “See-Through” effect is broken as the individual walks without image re-adjustments nor additional video streams to compensate. Thus, static “See-Though” and mobile “See-Though” are different technologies with different requirements. Our novel multi-use multi-vision modular invisible covers invention proves grander in scope, movement, and in warfare application than semi-invisibility party gags and tricks.

Public Domain also shows Mercedes-Benz toying with invisibility in the article, “Engineers use LEDs and a camera to create an ‘invisible’ Mercedes” on a civilian vehicle. Again, their engineers applied LED square kits for civilian applications using the same principles of the blue screen used by TV weather forecasters and Hollywood filmmakers. The LED square kits cannot be placed on moving parts, such as wheels and turrets, since the LED square kits are static within a centralized system. The Mercedes-Benz engineers failed to mention decentralized smart devices with multiple video streams designed for the hardships and the requirements of warfare. The inventions Mercedes-Benz invisible car is absent of modular smart devices or custom smart devices protecting and hiding military vehicles from the horrors of war with practical, reliable, scalable, and systematic invisibility methods. In contrast, the LED kits are a dumb terminal extension of a larger system and do not operate independently, which is a problem if the main control component is battle damaged, fails, and/or somebody spills coffee on its central computer. The Mercedes-Benz engineers failed to mention thermal neutralizing, X-ray neutralizing, night vision equalizing, nor multiple redundant video streams per device. Nothing about daisy chain video streams. Nothing about multiple “See-Through” videos stream sessions to replace another “See-Through” videos stream upon failing (ex. damage, explosions, interference). Nothing about combining shared video streams to improve or create a new video stream. Nothing about a management-of-management software to provision and onboard users, devices, and configurations. Nothing about Active Noise Controls to become auditory invisible. The articles even state that the wheels cannot be hidden due to the static wiring of the LED kits. In our invention, multiple modular smart devices with the modular layers and an embodiment of the invention can be attached to cover, hide, and protect the wheels of military vehicles, which Mercedes-Benz engineers failed to do. Our novel invisibility invention proves grander in scope, movement, and in warfare application than static layers of dummy LED mats dependent on a centralized system to create a semi-invisible civilian marketing joy ride.

Mr. Hyman's U.S. Pat. No. 8,921,473 “Image making medium” has the words ‘transparent’ and ‘invisible’ for any smart or intelligent material for creation of an aesthetic image that is a work or object for display. To summarize the invention, the image-making support medium that is a new reinvented version of the conventional utilitarian fine artist's canvas or mural support for artistic, design, and architectural expression using nanoparticles. Mr. Hyman's present invention relates to a medium-containing polymer that is useful for making images. Thus, their invention does not prefer cameras, displays, and/or devices produce video streams to create “See-Though” effects. Their invention was never intended nor for military use to create invisible cloaks, invisible armors, nor hiding vehicles. Nor for thermal invisibility. Nor night vision invisibility. On the positive side, Mr. Hyman's smart polymer solutions are a promising add-on to the novel invention of the multi-use multi-vision modular invisible covers, but not required, since a modified Life-Proof case and light-layer of plexiglass on a smart device can have the same or better effect than the application of the smart polymer.

Other polymer inventions with the words “Invisible”, “Transparent”, and “Cover” or “Hide” are U.S. Pat. No. 787,877 Panel, U.S. Pat. No. 9,673,149 Semiconductor device and manufacturing method thereof, U.S. Pat. No. 7,381,896 Wire hiding device and electrical apparatus having the same, and U.S. Pat. No. 8,664,625 Invisible three-dimensional image and methods for making, using and visibility of same. While U.S. Pat. No. 8,052,306 Electronic Apparatus does have the words “Invisible”, “Transparent”, and “Cover”, the electronic invention relates to a touch-screen display with a light emitting on its icon board.

The teachings of Patent Application US 20030154171, Patent Application US 20090099852, Patent Application U.S. Pat. No. 8,694,423, Patent Application US 20160063077, U.S. Pat. No. 8,429,040, Patent Application US 20130275177, Patent Application US 20080065409, Patent Application US 20120303754, Patent Application U.S. Pat. Nos. 7,113,998, 6,973,500, Patent Application US 20170177682 are incorporated herein by reference in their entirety. The present application incorporates in its entirety all the disclosures of U.S. Patent Application US 20130015236 filed on Jul. 15, 2011 and titled “High-value document authentication system and method.”

The present application incorporates in its entirety all the disclosures of U.S. Patent Application US20140229735 filed on Aug. 8, 2012 and titled “Managing device ownership and commissioning in public-key encrypted wireless networks.”

The present application incorporates in its entirety all the disclosures of U.S. Patent Application US20110258443 filed on Jul. 23, 2010 and titled “User authentication in a tag-based service.”

The present application incorporates in its entirety all the disclosures of U.S. Patent Application US20150199547 filed on Jan. 11, 2014 and titled “Method, system and apparatus for adapting the functionalities of a connected object associated with a user ID.”

The present application incorporates in its entirety all the disclosures of Field Manual FM 6-2 of the Tactics, Techniques, and Procedures for FIELD ARTILLERY SURVEY published by HEADQUARTERS DEPARTMENT OF THE ARMY, Washington, D.C., 23 Sep. 1993.

A geofence is a virtual perimeter for a real-world geographic area. A geofence can be generated as in a radius around a point location, such as a bar or a restaurant or mobile device. A geofence can be a predefined set of boundaries connecting points expressed by latitude and longitude. Geofencing has been made possible especially by the introduction of GPS (Global Positioning System) technology and the miniaturization of electronic components that have made the location-ing functionality a standard feature in smart devices and portable electronics in general (User Equipment). Geofencing can be implemented via many other localization techniques, both indoor and outdoor.

In this application the term ‘geofencing’ or “geofence” is not limited to virtual fences provided by storing one or more geographical locations and parameters that can be retrieved and then compared to actual locations obtained by using GPS positioning but shall include all the possible techniques that may serve the purpose of defining a geographical area by using digital or electronic means such as for example the radio horizon that defines the range of a radio carrier such as, e.g., 3G, 4G, WLAN, Bluetooth and RF-ID around a fixed or mobile point. This technology produces geolocation data in which a possible implementation of the invention is installed in (ex. device), which can be extracted and shared with other applications.

As technology advances, different methods have been described to interact with proximate objects using RF-ID technologies. Some disclosures pertain to location-based functionalities such as, e.g., U.S. Pat. No. 8,150,439 titled “Facilitating user interactions based on proximity”. Some other disclosure pertains to methods for controlling a target device using another device such as, e.g., in U.S. Pat. No. 8,504,008 titled “Virtual control panels using short-range communication.” Some other disclosures illustrate an identification and verification system that makes it possible for a user to easily open locks and/or gain entry to secured systems such as, e.g., in U.S. Pat. No. 8,430,310, titled “Wireless directional identification and verification using wearable electronic devices.”

Geofencing technology can trigger or inhibit functionalities of location-aware apparatuses. For example, as described in U.S. Pat. No. 7,813,741 titled “System and Method for Initiating Responses to Location-Based Events” a system may provide a response to one or more location-based services applications to provide location-based services, such as email, instant messaging, paging and the like. These interactions produced data, which are recorded within the user's account for their respective account (ex. mobile app level vs. desktop app level; Netflix vs. Amazon; device local user vs. network domain user). Location can be provided by many different techniques, for example triangulation with different Access Points or cellular Base Stations or signal strength data from various Access Point/Base Stations coupled with databases storing the location of various reference points. Geofencing technology can with other technologies, such as e-wearables (ex. AppleWatch, Fitbit).

The Facetime application and WhatsApp mobile application is an application that synchronizes cameras, video data, voice data, and other data to within the devices with the application and sharing networks for personal communications. The Facetime application is deployed in commercial devices to share its video conferencing sessions. The application can share data between telecoms networks and local LAN and Wi-Fi networks. Other similar applications, such as Google Hangout, Cisco Webex, and Microsoft Skype For Business applications, can do multiple video sharing sessions for the purpose of business meeting and social conferencing. However, none of the applications have the structure, features, and configuration to integrate, manage, synchronization, and distribution of video streaming “See-Through” experiences to create modular invisible armor types.

The Open Systems Interconnection model (OSI model) is a conceptual model that characterizes and standardizes the communication functions of a telecommunication or computing system without regard to its underlying internal structure and technology. Its goal is the interoperability of diverse communication systems with standard protocols. The model partitions a communication system into abstraction layers, which include the Physical Layer 1, Data Link Layer 2, Network Layer 3, Transport Link Layer 4, Session Link Layer 5, Presentation Link Layer 6, and Application Layer 7. The International Organization for Standardization (ISO) International, Computer Scientist Charles Bachman, and Telegraph and Telephone Consultative Committee (CCITT, from French: Comité Consultatif International Téléphonique et Télégraphique) cooperated to create these model standards for system interactions.

Virtual Local Area Network/s (VLAN) is a group of devices on one or more LANs that are configured to communicate as if they were attached to the same wire, when in fact they are located on a number of different LAN segments. Because VLANs are based on logical, instead of physical connections, they are extremely flexible. VLANs define broadcast domains in a Data Link Layer 2 network. A broadcast domain is the set of all devices that will receive broadcast data frames originating from any device within the set. Broadcast domains are typically bounded by routers, because routers do not forward broadcast frames. Data Link Layer 2 switches create broadcast domains based on the configuration of the switch. Switches are multiport bridges that allow the creation of multiple broadcast domains. Each broadcast domain is like a distinct virtual bridge within a switch. The configurator user can define one or many virtual bridges within a switch. Each virtual bridge the user creates in the switch defines a new broadcast domain (VLAN). Due to its virtual separation, traffic cannot pass directly to another VLAN (between broadcast domains) within the switch or between two switches. To interconnect two different VLANs, users normally use routers or other Network Layer 3 switches. Some modern switches can now bypass this VLAN-to-Switch Constraint information on inter-VLAN routing, such as the Cisco Catalyst 4500 series switches. Wireless switch and traditional switches can be virtualized as a function within an software instant, such a Packet Tracer, GNS3 Solar Winds, and/or within a device with OS platform that supports virtualization.

Virtualization applications create additional virtual environments within original environments. With more advanced skills, the inverse is true, where experienced network engineers can create a cluster computer hosts to create a singular virtual environment together. These types of applications range from VMware's Station Pro, Hyper-V, to Oracle's Virtual Box to. A simple example is live Microsoft Windows 10 environment using VMware Pro Station can upload the High Sierra Apple iOS. iso file to create and run a High Sierra Apple iOS simultaneously. Either process required an allocation of physical resources from the servers and/or devices to support a virtual environment.

Big Data Technologies are technologies that refine and often organize large (Petabytes and above) unstructured and/or structured data, which are, under normal circumstances, stored in server farms referred as Data Lake/s. Traditionally, big data software systems (like Hadoop, Cassandra, MongoDB, SAP Hana, etc. . . . ) transform large data in non-real-time batches and, with modifications and other apps (such as a Spark module, Guavas Reflex Platform), can handle and/or refine and/or process large amount of data in real time. These technologies require Virtualization tools (VMware, Oracle Virtual Box) and administration tools (Windows Server 20xx, Ubuntu Server) to create cluster server architectures to reduce failovers and unite them into Server Farms to produce Data Lakes, which Big Data Technologies interact with. In an optimal operation state, these technologies can currently handle and process 20 Petabytes of data per day. AT&T's NTC (Network Technology Centers), which include several service systems. One of them is the Switching Serving Customer Traffic with ATM Switches, Data Routers, Load Balancers, and ISDN Switches. Another system is the Security Nexus Access with distribution components like Firewalls, CONEXUS load balancers, severlets, and Landing Zones. Other systems include data feeds which consolidate structured or unstructured data from the source/s to the main location in a specific format/s (.cvs, .json, .txt). These data feeds can be assembled into large pools of information such as all the user's contacts, phone numbers called history, text messages sent, date of the events, system logs, and more. Data feeds can be internal to the organization, external to the organization, and a combination if multiple data feeds have the same software landing zones. Video data feeds are data feeds dedicated for video data. These are currently the 5+ Petabytes data pools that the Big Data Technologies feed from. But there are other methods of creating large data pools besides owning NTCs (like AT&T, Verizon, and Sprint) or having hundreds of data feeds. New methods to create data pools can include data storage decentralization systems where device users transfer and store the data in their smart phones. Or data block chain systems which try to follow the bitcoin model. NTC has a membership limitation problem and “mutually exclusive” game, since not all mobile phone users are subscribed to a single Service Provider (AT&T) and most users will not be subscribed to two Service Providers (AT&T subscriber and a Sprint subscriber) at the same time. Data feeds have the limitation of data integrity and format issues. Data feeds tend to be modified by the owners and no standardized data schemas are set. Thus, data feeds can conflict and create duplicate data in the data lakes or, worst, contaminate several data lakes with simple user error. The fact that most data feeds are no standardized, asynchronous, different formats, nor source connection is questionable, there is a constant data integrity issue. Video data feeds are more standardized due to UDP protocols, yet due to the constant production of images and unlabeled pixels. Thus, most visual data feeds are unlike to provide additional Big Data benefits without Artificial Intelligence (ex. facial recognition software for image libraries) to add content and meta tagging to images and pixels for any deep analysis. Although most Service Providers' networks function with one another's traditional wireless devices and current deploy Big Data technologies, the distance and data transmission between multiples devices in multiple different ISP networks will lag, experience problems in subterranean environments without relays, and are exponentially more complex than compared to multiple devices in a network within proximity connected by multiple redundant wireless technologies. As a Physical Layer 1 update, Big Data technologies have migrated from CPUs to GPUs due to the GPUs' exceptional ability to process random data structures compared to CPUs. Variations of the invention can include mix of an ISP's telecom network, military network (ex. SIPRNet, Nipr), and/or a P2P Wireless WAN with local LAN with Big Data technologies to manage the extensive amount of data (video, voice, data) produced by, as an example, 10 Navy Seal battalion with 250 invisible body armors and 50 invisible vehicle armor meshes configurations per Battalion.

As for Data Analytics Applications, there are over 30 variations of software like Tableau, Microsoft Power BI, IBM Cognos, Palantir's Gotham, and more. These software import data in a specific format/s to produce visualizations of the data into understandable images and business insights. This is normal for marketing research and government research which requires facts, data, graphs, charts, maps, and simplified statistics (ex. ratios, percentages) for decision making. These types of software have drill down/up abilities and unique features like heat maps to answer questions like “where do most people move around a mall?” or “How do people move their mouse on the website screen?” like the CrazyEgg Heatmap Software. Big Data Tools can refine and provide the required format for the Data Analytics Tools for optimal value by visualizing large statistical samples without collapsing the Data Analytics Tools in the process. In some implementations, these applications can be modified to interact with the inventions' software to set, measure, and/or deploy trigger mechanisms and other features.

Current video systems that broker images range from Cisco Telepresence Servers to Unifi Video Manager for multiple camera deployments. This system is designed to manage videos and cameras to capture, distribute, and, at times, store. These technologies support wireless devices and mobile services. However, they are not mobile in of themselves. Unifi Video Manager is hosted in operating systems for Windows 10, MS Server, Ubuntu, and other personal computer operating systems. The Unifi Mobile app shows the cameras on a mobile device; however, if the Unifi Video Manager application performs a shutdown, the mobile devices stop working. Thus, no Unifi Video Manager equals no video, since the management software supports the mobile network, but Unifi Video Manager is not deployed in a mobile device. The same goes with most technologies in the areas. Most networks are not 100% mobile network. Modern military naval vessels are close to this concept of mobile networks, yet their internal infrastructures are static and independent of the user, which if the user moves within the vessel, the infrastructure does not. Most ISPs deployed thousands of telecom towers around the globe to support for wireless devices. These infrastructures continue to be physical static infrastructures that support millions of mobile devices by to convert wireless signals into fiber signals in order to travel the ISP's networks center for validation, then to be converted back from fiber signals into wireless signals, which connects the respective device or endpoint. Satellite technology (ex. Dish Network with Satellite TV) exists and mainly for personal video-usage and non-business entities (ex. militaries, governments, NASA). In modern business, satellite is not the preferred method of connecting most LANs, WANs, ISP, and mobile device users in order to delivery video images due to many reasons, which include internet outages due to storming weather conditions. Thus, in the area of video brokering and distribution, no current technology deployment is 100% mobile. A true 100% mobile network would consist of a combination of mobile routers, mobile switches, mobile storage, mobile firewalls, mobile DHCP, mobile video management servers, mobile voice, mobile DNS, mobile video, mobile power, and/or mobile devices allowing the user and/or users to move inside mega structure buildings, underground bunkers, and/or underwater, while the network continues to function; this is one of the many aspects this invention presents.

Battery technologies vary from one-time-use AA lithium batteries to large backup recovery battery systems that keep ISP IT co-locations powered for days. Modern smartphone technology has inspired the launching of proximity wireless charging technologies into the market like iPhone X Wireless Charge or the Qi Belkin Boost 7.5 W Qi Charging Pad. These proximity wireless charging technologies have been around since the late 19th century, when electricity pioneer Nikola Tesla demonstrated magnetic resonant coupling. The ability to transmit electricity through the air by creating a magnetic field between two circuits, a transmitter, and a receiver. But, for about 100 years, technology had few practical applications in the 19^{th} century. Today, there are many wireless charging technologies in use, all aimed at cutting cables to improving lifestyle choices from smartphones and laptops to kitchen appliances and cars. Yet, most of the charging technologies are static and not designed to charge while the charger unit and the devices are in motion. Nor are the devices set to daisy chain the charging power to other devices as conduits. No has such inventions been applied to power invisible mobile armors from a plurality of devices, which can further requirements, such an internal layer of body armor integration, human sweat, the jolts of battle, and/or bullets.

Autonomous Flying Robots (Patent Application JP 2012272748A) were displayed in TED by Dr. Vijay Kumar, Pennsylvania State University, in 2012. Within this technology presentation, the flying robots CPUs and logic gave over 500 commands per second to the motors. The robots interact and manage the elements of blades speeds, lift, inertia, and/or acceleration linear angular. The mentioned usage of such capacities where CBRN analysis, construction, playing music, intruder attack detection (as stated in their prior art patent), and/or rescue operations using Minimum Snap Projectories, non-GPS navigations, and/or swarm coordination software to synchronize multiple flying robots. The presentation also demonstrated the ability of an individual to throw one of these robots in the air and for the robot to recover to a stable hovering state. Dr. Vijay Kumar and Haruyuki Amamoto (the inventor of the prior art) failed to mention the use of flying robots to form wall formats to create invisible armor shields. Nor did the TED presentation mentioned how such devices synergies and integrate with other devices, such as the flying robot been an invisible device of individual's invisible body armor in order to be thrown as a scout robot and return to the individual's body armor position. The autonomous flying robots technology is ideal for such invisible flying wall formations, but, the truth is that such autonomous robotic technology would require major upgrades to the flying robots (ex. adding displays on the robotic structures for the video to transmit) and changes to the software code (ex. the coordination of video transmissions changes based on changes of the invisible flying wall.) to perform such an advance invisibility combined arms. In addition, swarm technology may not be ideal in all situation in its current technological stage due to its infancy as a technology while human judgment via remote controls may be more suitable. In addition, the loud buzzing sounds of these autonomous flying robots are too noisy for a tactical environment requiring silence for the element of surprise.

Active noise control (ANC) technologies, also known as noise cancellation, or active noise reduction (ANR), is a method for reducing unwanted sound by the addition of a second sound specifically designed to cancel the first. Sound is a pressure wave, which consists of alternating periods of compression and rarefaction. A noise-cancellation speaker emits a sound wave with the same amplitude, but with inverted phase (also known as antiphase) to the original sound. The waves combine to form a new wave, in a process called interference, and effectively cancel each other out. This effect is called destructive interference. Modern active noise control is generally achieved through the use of analog circuits and/or digital signal processing. Adaptive algorithms are designed to analyze the waveform of the background aural or non-aural noise, then based on the specific algorithm generate a signal that will either phase shift or invert the polarity of the original signal. This inverted signal (in antiphase) is then amplified and a transducer creates a sound wave directly proportional to the amplitude of the original waveform, creating destructive interference. This effectively reduces the volume of the perceivable noise. A noise-cancellation speaker may be co-located with the sound source to be attenuated. In this case, the noise-cancellation speaker produce the same audio power level as the source of the unwanted sound. Alternatively, the transducer emitting the cancellation signal may be located at the location where sound attenuation is wanted (e.g. the user's ear). This requires a much lower power level for cancellation but is effective only for a single user. Noise cancellation at other locations is more difficult as the three-dimensional wavefronts of the unwanted sound and the cancellation signal could match and create alternating zones of constructive and destructive interference, reducing noise in some spots while doubling noise in others. In small enclosed spaces (e.g. the passenger compartment of a car) global noise reduction can be achieved via multiple speakers and feedback microphones, and measurement of the modal responses of the enclosure. These noise cancelation technologies could be used to cancel or reduce any noises produce by large invisible flying formations of thousands of autonomous flying robots; or human sounds (ex. coughs, footsteps, bodily functions) produced by a tactical team wearing invisible body armors enhance with active noise controls.

Air control systems are technologies that modify the temperature by cooling or heating their environment and/or mechanisms based on open, mixed, and/or close systems. There are different variants, such as water cooled, air cooled, oil cooled, and/or mixed. Astronautic equipment and deep-water aquatic suits normally have their own air conditioning unit, but they are closed systems and not designed for invisibility. Some of these smart devices can be quickly upgraded with a commercial AC unit, such as a X-Naut Cooling Case for iPad Mini. New grounds are open when multiple smart devices in a network use their AC units to modify the temperate of a human, a group of humans, and/or vehicles simultaneously at the same temperature environment in order to cancel or reduce thermal signals. Perhaps even cool those humans and equipment by redirecting and/or reflecting intense sunlight.

The present invention combines, adapts, and adds to some of the above-mentioned concepts, technologies and observations by way of a synergetic and novel approach a method, a system and an apparatus to, e.g., improve visual invisibility, video streaming for “See-Through” effects, thermal invisibility, night-vision invisibility, x-ray invisibility, 100% mobile networks, daisy chaining power sharing, unified modular armors, flying drone invisible wall formations, personal cooling systems, tactical group silence, and/or items address in this invention.

### SUMMARY

Various aspects of examples of the invention are set out in the claims.

A method of the present invention for facilitating the creation of multi-use multi-vision modular invisible covers and efficiently managing groupings by aggregating multiple displays, cameras, and/or devices into physical meshes and virtual networks to produce multiple video stream “See-Through” effects between meshed displays, cameras, and/or devices using their very displays and cameras. In the modern battlefields, multiple forms of vision are used to spot friendly forces and enemy forces. And upon detection, the war engagement starts. With this technology, users and the equipment can create different levels of invisibility and protection, which include the visual level, thermal level, night vision level, x-ray gamma level, and/or noise level. These modular mesh devices quickly sync and join their respective network and can be deployed in many configurations from individual invisible cloaks to invisible body armors to land drones to large vehicles, watercrafts, and/or spacecrafts. The devices can be reinforced and/or enhance with alloys, non-alloys, non-commercial add-ons, commercial adds-ons to improve defenses, increase power-sharing capacities, resist many terrains, regulate temperatures, and/or reduce x-ray and radiation emissions. These novel unique systems solve the age-old question if invisibility exists outside of smoke, magician tricks, movies with special effects, electromagnetic ruses, classic use of mirrors, or fictitious magical rings (ex. the Ring of Power within ‘Lord of the Rings’ by J. R. R. Tolkien, which is a concept that Tolkien, the British World War 1 Veteran, copied from the child molesting Socrates, the protagonist of ‘Plato's Republic’. While Alejandro Evaristo Perez, the US Army War Veteran and the author of this patent, wrote a novel ‘The Real Lord Vaders|The Destroyers of Star Wars’ introducing the practical use of invisibility technology as layered smart devices using bi-directional cameras in a practical recon scenario. Thus, no rings from a mystical realm of Mordor with God-like powers; nor debating moral dilemma whether one would be righteous if handed invisibility ring in Ancient Greece). This invention instead provides a systematic and scientific approach to deploying invisibility by a network of mobile devices, displays, and cameras synched to exchange video streams that produce the “See-Through” invisibility effect desired and adjust with movement. Depending of the type of configuration and, upon triggering, the modular invisible armor types can react and modify with the changing conditions. Upon damages, movement, and/or operator error, the invisibility systems have mechanisms to auto correct, redirect, replace video streams, and/or share cameras and displays. In dual device formats, a simple “poke-oke” display switch can quickly correct the invisibility video streaming. Upon “See-Through” no longer being a practical tactical application, the devices, cameras, and displays swift to create confusion and blind onlookers with light flashes and modified their video streams.

A second aspect of the present invention, any invisible device in the network can be upgraded with flight capabilities to be thrown or self-detach from the plurality of devices to transform into an invisible scouting device. The upgraded flying device can return to the user or vehicle configuration to take its respective place in the configuration.

According to a third aspect of the present invention, a plurality of devices, cameras, and/or displays in the network can be upgrade with autonomous flight capabilities to create invisible flying autonomous wall formations that coordinate to protect, hide, and/or save the users, vehicles, equipment, and other strategic elements. To counter the loud buzz sounds from the drone formations and remain stealthy, the devices, cameras, and/or displays can be equipped with Active Noise Control enhancements to reduce and cancel the roars of thousands of invisible modular flight robots.

According to a third aspect of the present invention, a computer software system has a set of instructions for controlling at least one general-purpose digital smart device in performing desired functions comprising a set of instructions formed into each of a plurality of modules, each modules comprising of 1) a smart device (ex. iPhone) as a user equipment; 2) a process for receiving a location data associated from said user equipment (ex. Google Maps, GPS location consented) to open video transmission; 3) a process for comparing said location data with a location of record for another set user equipment (ex. e-wearable) to transfer video transmission with validated authentication, (ex. biometric, Mac-Address, pin). 4) a process for securely producing, brokering, and transferring video streams to a set location to generate “See-Through” in respective invisibility configurations; 5.) a process and method of selecting, matching, processing, re-adjusting, and/or recording video streams with their configurations and accesses.

A fourth aspect of the present application focuses on a hierarchical and systematic method of data collection and video distribution from users so that the computer hardware needed to execute the functionalities described herein accomplishes tasks more efficiently and reliably. In this implementation, the data collected and distributed from users' accounts can be divided into at least two subsets. The first data-type set is used to rank the video streams of users according to a series of parameters and protocols as usefulness to a specific invisibility configuration (ex. the use of VLANs, Layer 2 IEEE 802.1Q frame headers carry the CoS value in the 3 most significant bits of the Tag Control Information field, and Administrative Distances between routes within a network) to produce their image quality in relation to “See-Through” effect desired. The second type data is the actual meshing set of video streams that are extracted by the various users that are pertinent to said specific invisibility type to create secondary video streams to compensate for failures in the initial first data-type set based on set parameters (ex. exchange and over-impose secondary videos stream based on pixelation range tables) if prefabricated video streams are not available. In certain implementations, there is a permission to be asked to the various invisibility administrator to access the invisibility configurations and set parameters. Said permission can be asked hierarchically starting first with those video streams that fit the invisibility configuration most closely or are more credible according to predetermined parameters. In other implementations, the access to said second set of video streams can occur automatically if the invisibility user's configuration has triggered the parameters set by the invisibility administrator. The harvesting of second type video data sets may occur hierarchically, starting with the invisibility user that according to type one video data set provided the most value (ex. selecting image pixelation quality vs. selecting Administrative Distance of routes). A hierarchical approach to data streams, (starting with higher tier video streams and only in a second stage, if needed, to collect, hyper-impose video streams, and redistribute to the new routes, which was collected from shared cameras), will result in improved utilization of the invisibility computing and communication resources. Higher tiers of video streams mean, (ex. those videos that have a High Definition [HD]) provide data that are more related and richer in graphics for the specific invisibility configuration. Pixelation algorithms and Artificial Intelligence (AI) crawlers may dynamically compensate for low-quality video streams concerning second type subset videos streams by making hardware changes and enlarging the shared camera population size within invisibility configurations (ex. increasing imposed video stream from 2 shared cameras to 4 shared cameras). Other selection systems and methods can be used such as comparison sorts (ex. bubble sort, insertion sort, merge sort, LIFO, FIFO, etc.) and non-comparison sorts (Radix sort, Bucket sort, etc.). Many algorithms can be implemented that can be adaptive and learn over a period of time or usage.

A fifth aspect of the invention is an computer software program that sets, instructs, and coordinates users, drones, configurations, watercraft, aircraft, spacecraft, vehicles, cloaks, and devices to perform Invisibility Combined Arms Actions, which accounts for the discrepancy of turbine power versus simple drone propellers, the distances of each invisible flying wall formations of invisible modular drones in invisible defensive postures; slow invisible infantry support; and/or invisible aircraft take-offs and arrivals to airports to hide and/or protect the aircraft during exposure; and with safety mechanisms to stop any devices from becoming safety hazards to the aircraft and the crew. Such safety enhancements can be programmed. In addition, the sharing cameras and the number of cameras allows developers with administration access to program custom features to targeting systems of any craft.

In certain implementations, invisibility users belonging to different tiers to access different feature sets based on configurations. For example, local invisibility users may control their respective modular invisibility cover configurations (ex. invisible cloak and invisible body armor), while an invisibility administrator may manage several invisibility configurations and/or deployments both locally and remotely, which can consist of invisible body armors, cloaks, craft armors, invisibility drones, and more.

### BRIEF DESCRIPTION OF THE DRAWINGS

For more a complete understanding of example embodiments of the present invention, reference is now made to the following descriptions taken regarding the accompanying drawing in which:

FIG. 1 represents a simplified possible schematic embodiment of the invention describing the methods, system, and apparatus for an invisible personal body modular armor type, which consist of the multiple smart devices (User Equipment—UE) meshed on a basic body armor with groin protection. All devices are connected transmitting video streams to the polar-opposite devices in order to create a “See-Through” effect. The invention can have methods to correct camera problems, such as damages. This correction allows the other devices to send and collect the video stream from other devices and pick the best video to stream; and/or create a new image based on the images from other cameras, as shown with Image 1 and Image 2, when several cameras from those UEs share and process the best video stream to be transmitted. The armors can consist of different UE types and it is assumed that the UE can be a combination of generic commercial devices, custom commercial devices, and/or military-grade devices.

FIG. 2 represents a simplified possible schematic embodiment of the invention describing the methods, system, and apparatus for an invisible personal modular cloak armor type, which consist of the multiple smart devices meshed on a basic body armor with groin protection. All devices are connected transmitting video streams to the polar-opposite devices in order to create a “See-Through” effect. The invention can have methods to ensure multiple connections between different UE to create mediums, such as Wi-Fi, Ethernet, Bluetooth, and other wired/wireless technologies to ensure redundancy, availability, and quality of services for image exchanges.

FIG. 3 represents a simplified possible schematic embodiment of the invention describing the methods, system, and apparatus for an invisible personal modular cloak type, which consist of the multiple smart devices meshed to around a protective blanket netting surrounding a basic body armor with groin protection enhanced with UE. All devices are connected transmitting video streams to the polar-opposite devices in order to create a “See-Through” effect. These combinations UE and separate configuration can and should harmonize and synchronize to ensure the quality of the “See-Through” effect. The invention can have methods to ensure multiple connections between different UE to create mediums, such as Wi-Fi, Ethernet, Bluetooth, and other wired/wireless technologies to ensure redundancy, availability, and quality of services for image exchanges. The invisible modular cloak types can consist of different UE types and it is assumed that the UE can be a combination of generic commercial devices, custom commercial devices, and/or military-grade devices.

FIG. 4 represents a simplified possible schematic embodiment of the invention describing the methods, system, and apparatus for mix combination of invisible personal body modular armor type and invisible personal modular cloak type, which consists of the multiple smart devices, cameras, and displays meshed to around a protective blanket netting. All devices are connected transmitting video streams to the polar-opposite devices in order to create a “See-Through” effect. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges. The invisible modular armor and cloak types can consist of different UE types and it is assumed that the UE can be a combination of generic commercial devices, custom commercial devices, and/or military-grade devices.

FIG. 5 represents a simplified possible schematic embodiment of the invention describing a system implementation of the two smartphone UE sharing images and video streams between two polar-opposite UE to create and illustrate a simplified “See-Through” Effect via video image exchanges. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges.

FIG. 6 represents a simplified possible schematic embodiment of the invention describing a system implementation of the two smart watches UE sharing images and video streams between two polar-opposite UE to create and illustrate a simplified “See-Through” Effect via video image exchanges. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges.

FIG. 7 represents a simplified possible schematic embodiment of the invention describing a system implementation of the two smart devices UE sharing images and video streams between two polar-opposite UE to create and illustrate a simplified “See-Through” Effect via video image exchanges. The two UE are placed back to back to illustrate a side view of the “See-Through” Effect. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges.

FIG. 8 represents a simplified possible schematic embodiment of the invention describing a system implementation of the multiple smart devices UE on a personal body armor and sharing video image streams between multiple polar-opposite UE to create and illustrate a simplified “See-Through” Effect via video image exchanges. The multiple UE are placed back to back to illustrate a side view of the “See-Through” Effect. The multiple UE share cameras to capture images to ensure quality and video redundancy of the invisibility. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges.

FIG. 9 represents a simplified possible schematic embodiment of the invention describing a system implementation of the multiple smart devices UE and a technical network configuration for sharing video image streams between multiple polar-opposite UE to create and illustrate a simplified “See-Through” Effect via video image exchanges. The multiple UE are placed back to back to illustrate a side view of the “See-Through” Effect. The multiple UE share cameras to capture images to ensure quality and video redundancy of the invisibility and when a UE become disabled or broken, the other UE share images to compensate based on the sorting and selection methods and criteria in order to choose which cameras to broadcast to which displays, which is what is referred to as Self-Correcting Video Streams. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges. This configuration shows the VLANs with a variety of direct lines with Administrative Distances of 0, which upon damage, a new route and thus a new VLAN would be choosing to assist the methods of Self-Correcting Video Streams.

FIG. 10 represents a simplified possible schematic embodiment of the invention describing a system implementation of the two smart devices UE sharing the same images and video streams between two polar-opposite UE to create duplication and quickly support “See-Through” Effect exchanges via video image exchanges. The two UE are placed back to back to illustrate a side view of the “See-Through” Effect while equipped with modular layer systems. This dual variant can unify two UE to be a single unit for “poke-oke” redundancy if the user installed the UE incorrectly; or one side of dual UE's display is damaged, the dual UE can be flipped as a quick replacement. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges. This dual UE example, the modular layer system can consist of an armor layer, which can be alloys, non-alloys, and/or a combination of both. Another layer can consist of a slap of metallic lead to stop any x-rays. Another layer can consist of the battery energy layer where batteries, solar-power panels, wireless charging units, and/or other energy battery technology can be implemented. An Air Conditioning Layer (ex. coils) can be added if thermal neutralizing is needed and/or cooling the user and/or craft. The layers can be changed and added accordingly. Ideally, the layers should be able to be installed, configured, and reconfigured by the user with ease.

FIG. 11 represents a simplified possible schematic embodiment of the invention describing the methods, system, and apparatus for invisible personal body modular armor type, which consist of the multiple dual devices meshed on a heavy body armor variant. In this heavy armor variant, all dual UE with Modular Layer System are connected and transmitting video streams to the polar-opposite devices in order to create a “See-Through” effect. The invention can have methods to correct camera problems, such as damages. This correction allows the other devices to send and collect the video stream from other devices and pick the best video to stream; and/or create a new image based on the images from other cameras when several cameras from those UEs share and process the best video stream to be transmitted. The invisible modular armor types can consist of different UE types and it is assumed that the UE can be a combination of generic commercial devices, custom commercial devices, and/or military-grade devices.

FIG. 12 represents a simplified possible schematic embodiment of the invention describing the methods, system, and apparatus for an invisible personal body modular armor type, which consists of the multiple dual UE meshed on a heavy body armor with groin protection, an invisible heavy Kevlar helmet variant, and network equipment to create a 100% mobile network making it independent of Telcom communications. In this heavy armor variant, all dual UE with Modular Layer System are connected transmitting video streams to the polar-opposite devices in order to create a “See-Through” effect. The invention can have methods to correct camera problems, such as damages. This correction allows the other devices to send and collect the video stream from other devices and pick the best video to stream; and/or create a new image based on the images from other cameras when several cameras from those UEs share and process the best video stream to be transmitted. The invisible modular armor types can consist of different UE types and it is assumed that the UE can be a combination of generic commercial devices, custom commercial devices, and/or military-grade devices.

FIG. 13 represents a simplified possible schematic embodiment of the invention describing the methods, system, and apparatus for an invisible personal body modular armor types with modular invisible shields, which consist of the multiple dual UE meshed on a police body armor with groin protection. In this police armor variant, all dual UE with Modular Layer System are connected transmitting video streams to the polar-opposite devices in order to create a “See-Through” effect. The invention can have methods to correct camera problems, such as damages. This correction allows the other devices to send and collect the video stream from other devices and pick the best video to stream; and/or create a new image based on the images from other cameras when several cameras from those UEs share and process the best video stream to be transmitted. The UE display can project messages upon the displays of the devices. The invisible modular armor types can consist of different UE types and it is assumed that the UE can be a combination of generic commercial devices, custom commercial devices, and/or military-grade devices. The FIGURE focuses more on illustrating the use of generic modular UE to create invisible personal body armor types.

FIG. 14 represents a simplified possible schematic embodiment of the invention describing the methods, system, and apparatus for an invisible personal body modular armor types with custom invisible shields, which consist of the multiple dual UE meshed on a police body armor with groin protection. In this police armor variant, all dual UE with Modular Layer System are connected transmitting video streams to the polar-opposite devices in order to create a “See-Through” effect. The invention can have methods to correct camera problems, such as damages. This correction allows the other devices to send and collect the video stream from other devices and pick the best video to stream; and/or create a new image based on the images from other cameras when several cameras from those UEs share and process the best video stream to be transmitted. The UE display can project messages upon the displays of the devices. The invisible armor types can consist of different UE types and it is assumed that the UE can be a combination of generic commercial devices, custom commercial devices, and/or military-grade devices. The FIGURE focuses more on illustrating the use of custom UE to mix with generic UE to create invisible personal body armor types.

FIG. 15 represents a simplified possible schematic embodiment of the invention describing the methods, system, and apparatus for mix combination of invisible personal body modular armor type and invisible personal modular cloak type, which consist of the multiple UE and dual UE meshed to around a protective blanket netting, a heavy body armor variant, a custom invisible shield, and an invisible medium Kevlar helmet variant. All devices are connected transmitting video streams to the polar-opposite devices in order to create a “See-Through” effect. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges. The combination can consist of different UE types and it is assumed that the UE can be a combination of generic commercial devices, custom commercial devices, and/or military-grade devices.

FIG. 16 represents a simplified possible schematic embodiment of the invention describing the methods, system, and apparatus for mix combination of invisible personal body modular armor type and invisible personal modular cloak type, which consist of the multiple UE and dual UE meshed to around a protective blanket netting and a heavy body armor variant. In this case, the user can use an UE (or any UE, ideally) to configure the user's invisible armor and invisible cloak combination. All devices are connected transmitting video streams to the polar-opposite devices in order to create a “See-Through” effect. Using the limited version of the invisibility portal, the user can select a Power Saving mode could reduce or stop the transmissions between UE in the configurations to save power and battery. Or the user could choose “Full Invisibility” mode to command all UE types and mixes to harmonize and synch their respective UE cameras. Besides a simple GUI to perform these and more commands, the User can execute Voice and Motion commands, but not ideal in stealth operations, where stillness and silence is critical. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges. The cloaks and armors can consist of different UE types and it is assumed that the UE can be a combination of generic commercial devices, custom commercial devices, and/or military-grade devices.

FIG. 17 represents a simplified possible schematic embodiment of the invention describing the methods, system, and apparatus for software administration portal to mix combination of invisible personal body modular armor type, UE, groups, users, invisible personal modular cloak types, invisible vehicular modular armors, invisible modular drones, invisible modular flying walls, and other UE and/or custom configurations. In this case, the user can be an administrator utilizing an UE to configure, manage, test, and/or provision all of the combinations mentioned previously to deploy Invisibility Combined Arms. With these portals, all configuration can be uniquely grouped and connected to transmit video streams to the polar-opposite devices and thus create a “See-Through” effect in individual configuration to massive scales of multiple configurations into deployments. In this example, the Administrator should be able ‘Upgrade’ and provision a new Helmet UE on a User quickly and easily with a simple UI commands. Voice and motion commands could be used, but not ideal in tactical environments. Power Saving mode could reduce or stop the transmissions between UE in the configurations to save power and battery. Or the user could choose “Full Invisibility” mode to command all UE types and mixes to harmonize and synch their respective UE cameras. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges. The cloaks can consist of different UE types and it is assumed that the UE can be a combination of generic commercial devices, custom commercial devices, and/or military-grade devices.

FIG. 18 represents a simplified possible schematic embodiment of the invention describing the methods, system, and apparatus for mix combination of invisible modular flying drone types, both light and heavy styles. These flying drones are equipped with UE types. All devices are connected transmitting video streams to the polar-opposite devices in order to create a “See-Through” effect. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges. The combination can consist of different UE types and it is assumed that the UE can be a combination of generic commercial devices, custom commercial devices, and/or military-grade devices. The user can be a local user, a remote user, auto-programmed, and/or connected to a swarm technology software. Besides a simple GUI, Voice and Motion commands could be used by user and administrator on the invisible flying modular drones, but not ideal in tactical environments.

FIG. 19 represents a simplified possible schematic embodiment of the invention describing the methods, system, and apparatus for multiple combinations of invisible modular flying drone types, both light and heavy style, and a mix of invisible armor and cloak type. These flying drones are equipped with UE types. All UEs are connected transmitting video streams to the polar-opposite devices in order to create a “See-Through” effect. In this example, the invisible modular flying drone types use the invention and methods daisy chain communications to ensure multiple connections between different UE to create mediums, such as Wi-Fi, Ethernet, Bluetooth, ISP Telcom, and other wired/wireless technologies to ensure redundancy, availability, and quality of services for image exchanges. The combination can consist of different UE types and it is assumed that the UE can be a combination of generic commercial devices, custom commercial devices, and/or military-grade devices. The user can be a local user, an remote user, auto-programmed, and/or connected to a swarm technology software. The illustration focuses on stretching the formations and still retain connectivity between all UE. Besides a simple GUI, Voice and Motion commands could be used by user and administrator on the invisible flying modular drones, but not ideal in tactical environments.

FIG. 20 represents a simplified possible schematic embodiment of the invention describing the methods, system, and apparatus for massive combinations of invisible modular flying drone types, both light and heavy styles in order to create a flying invisibility wall that quickly protect and hide whatever is behind them. These flying drones are equipped with UE types. All UEs are connected transmitting video streams to the polar-opposite devices in order to create a “See-Through” effect. In this example, the invisible modular flying drone types use the invention and methods daisy chain communications to ensure multiple connections and synchronization between different UE to create mediums, such as Wi-Fi, Ethernet, Bluetooth, ISP Telcom, and other wired/wireless technologies to ensure redundancy, availability, and quality of services for image exchanges. The combination can consist of different UE types and it is assumed that the UE can be a combination of generic commercial devices, custom commercial devices, and/or military-grade devices. The user can be a local user, a remote user, auto-programmed, and/or connected to a swarm technology software. The illustration focuses on stretching the formations and still retain connectivity between all UE. Besides a simple GUI, Voice and Motion commands could be used by user and administrator on the invisible flying modular drones, but not ideal in tactical environments.

FIG. 21 represents a simplified possible schematic embodiment of the invention describing the methods, system, and apparatus for a combinations of invisible modular flying drone types, both light and heavy style, and an invisible modular armor cloak mix in order to create a flying invisibility personal wall (at least, for additional protection) that quickly protects and hide the user. These flying drones are equipped with UE types. All UEs are connected transmitting video streams to the polar-opposite devices in order to create a “See-Through” effect. Besides protection, the user can order the invisible modular flying drone types to scout in front of the user for safety and reduce exposure. The invisible modular flying drone types use the invention and methods daisy chain communications to ensure multiple connections between different UE to create video stream exchanges, such as Wi-Fi, Ethernet, Bluetooth, ISP Telcom, and other wired/wireless technologies to ensure redundancy, availability, and quality of services for image exchanges. The combination can consist of different UE types and it is assumed that the UE can be a combination of generic commercial devices, custom commercial devices, and/or military-grade devices. The user can be a local user, a remote user, auto-programmed, and/or connected to a swarm technology software. The illustration focuses on stretching the formations and still retain connectivity between all UE. In such formations, the buzzing sounds of invisible flying drones would be obvious to human ears. Thus, for tactical reasons, Active noise control (ANC) technologies, also known as noise cancellation, or active noise reduction (ANR) will likely be required to reduced unwanted sound, which can be countered with the UE's speakers, the UE's voice receivers, and/or other enhancements.

FIG. 22 represents a simplified possible schematic embodiment of the invention describing the methods, system, and apparatus for an invisible modular craft light armor type, which can consist of a multiple and mixed single UE and dual UE meshed on a helicopter. In this light armor variant, all variants of UE with Modular Layer System are connected transmitting video streams to the polar-opposite devices in order to create a “See-Through” effect. In this case, this invisible modular craft light armor type should attempt to hide or reduce the visual exposure of the helicopter. The invention can have methods to correct camera problems, such as damages. This correction allows the other devices to send and collect the video stream from other devices and pick the best video to stream; and/or create a new image based on the images from other cameras when several cameras from those devices share and process the best video stream to be transmitted. This system of video image correction will be critical in a case of fast-moving crafts, such as helicopters, airplanes, space craft, PT-boats, etc. . . . . These problems are more prevent in Telcom2Telcom video streaming, which can be UE sending video stream to ISP 1 tower, ISP 1 tower to ISP 1 data center via Fiber, then to the next ISP 1 data center via Fiber to ISP 2 data center via Fiber, ISP 2 data center to ISP 2 tower, and finally, ISP 2 tower to second UE. Whereas a UE can send a signal to another UE via Wi-Fi and/or Bluetooth reducing the data hops. For that very reason, variants of the invention likely to require multiple methods to ensure multiple connections between different UE to create mediums, such as Wi-Fi, Ethernet, Bluetooth, ISP Telcom, and other wired/wireless technologies to ensure redundancy, availability, and quality of services for image exchanges. The invisible modular craft armor types can consist of different UE types and it is assumed that the UE can be a combination of generic commercial devices, custom commercial devices, and/or military-grade devices.

FIG. 23 represents a simplified possible schematic embodiment of the invention describing the methods, system, and apparatus for an invisible modular craft light armor type, which can consist of a multiple and mixed single UE and dual UE meshed on a helicopter; and a wall of invisible flying drones in a protective formation around the helicopter. In this light armor variant, all variants of UE with Modular Layer System are connected transmitting video streams to the polar-opposite devices in order to create a “See-Through” effect. In this case, this invisible modular craft light armor type should attempt to hide or reduce the visual exposure of the helicopter; while the invisible flying drones wall formations provide additional protection and features around the helicopters via invisibility combined arms. Due to the discrepancy of helicopter turbine power versus simple drone propellers, the invisible flying wall formations of modular drones will likely be implemented as defensive postures; slow infantry support; and/or helicopter take-offs and arrivals to helipads to hide and/or protect the helicopters during hovering exposure, but with enough distance to stop any UE from become safety hazard to the helicopter and the crew. Such safety enhancements can be programmed. In addition, due to the nature of sharing cameras between UE, developers with administration access can link this feature to the defense and attack systems of any craft, in this example, a helicopters' defense flying wall defenses and a counter anti-missile defense system. The invention can have methods to correct camera problems, such as damages. This correction allows the other devices to send and collect the video stream from other devices and pick the best video to stream; and/or create a new image based on the images from other cameras when several cameras from those UEs share and process the best video stream to be transmitted. This system of video image correction will be critical in a case of fast-moving crafts, such as helicopters, airplanes, space craft, etc. . . . . These problems are more obvious in Telcom2Telcom video streaming, which can be UE sending video stream to ISP 1 tower, ISP 1 tower to ISP 1 data center via Fiber, then to the next ISP 1 data center via Fiber to ISP 2 data center via Fiber, ISP 2 data center to ISP 2 tower, and finally, ISP 2 tower to second UE. Whereas a UE can send a signal to another UE via Wi-Fi and/or Bluetooth reducing the data hops. For that very reason, variants of the invention likely to require multiple methods to ensure multiple connections between different UE to create mediums, such as Wi-Fi, Ethernet, Bluetooth, ISP Telcom, and other wired/wireless technologies to ensure redundancy, availability, and quality of services for image exchanges.

FIG. 24 represents a simplified possible schematic embodiment of the invention describing the methods, system, and apparatus for invisible modular craft armor types modified to civilian tractor vehicles to form invisible mobile wall formations, which consist of mounting multiple large custom heavy variant dual UE. All UE are connected transmitting video streams to the polar-opposite devices in order to create a “See-Through” effect. In this case, UE attached on the back of the civilian tractor cab has been configured to exchange signals with the invisible modular craft type mounted. This example focuses on mixing the modularity and custom types to mobilize civilian transports and civilian machinery for civic defense efforts. Such civilian vehicle mobilization can be used as quick fortifications of areas of operations and simple invisible city walls to hide civilian populations from the rage of war.

FIG. 25 represents a simplified possible schematic embodiment of the invention describing the methods, system, and apparatus for mix combination of invisible personal body modular armor types, invisible module craft armor types, and invisible personal modular cloak type, invisible modular flying drone variants, and other invisible configuration deployments which consist of the multiple UE and dual UE meshed to around a protective blanket netting, a body armor variants, a custom invisible shield, drones, an invisible Kevlar helmet variants, helicopters, and more. All devices are connected transmitting video streams to the polar-opposite devices in order to create a “See-Through” effect. The invention can have methods to ensure multiple connections between different UE to create mediums, such as Wi-Fi, Ethernet, Bluetooth, ISP Telcom, and other wired/wireless technologies to ensure redundancy, availability, and quality of services for image exchanges. In this case, all the different invisibility configurations should enable any unit level commander to perform Invisibly Combined Arms to support infantry advancements via the help of an admin portal. The combination can consist of different UE types and it is assumed that the UE can be a combination of generic commercial devices, custom commercial devices, and/or military-grade devices. In such massive formations, the buzzing sounds of thousands of invisible flying drones, helicopter turbines, loud civilian tractors, and/or human military moment would be obvious to human ears. Thus, for tactical reasons, Active noise control (ANC) technologies, which can be countered with the UE's speakers, the UE's voice receivers, and/or other enhancements.

FIG. 26 represents a simplified possible schematic embodiment of the invention describing the methods, system, and apparatus for mix combination of invisible modular body armor types, invisibility cloaks, and an invisibility modular drones in an Invisible Hyper-Modular format where the UE have been miniaturized by technological advancements and manage via an embodiment of the invisibility portal with MoM HCS-style module to handles millions of endpoints and video streams exchanges supported by multiple broadcast channels from Bluetooth, Wi-Fi, Telecoms, Ethernet mods, and more.

FIG. 27 represents a simplified possible schematic workflow of the invention describing the methods, system, and apparatus for interactions between the software administration portal and a mix combination of invisible personal body modular armor type, devices, e-wearables, groups, users, invisible personal modular cloak types, invisible vehicular modular armors, invisible modular drones, invisible modular flying walls, video stream exchange reconfiguration and other UE configurations and/or custom configurations based on criteria, logic conditions, sorting actions, port switching between video streams, and quality testing within the portal's environment and the respective UE. In this case, any User can grab an UE and quickly become Invisibility Administrator; and now utilizing an UE 101 (or any, ideally) to update the Criteria 1.

### GLOSSARY

The person skilled in the art knows that terms such as invisibility, covers, body armor, cameras, streaming, displays, devices, smart devices, e-wearables, synchronizing and exchanging video sessions, batteries, profiles of users, organizations, or companies and other elements that are stored on non-volatile memory in a computer machine or server. Informally, throughout the present patent application, these and other terms might sometimes be used as proxies for users, companies and/or organizations that are linked to datagram/s. Invisibility instances are collections of organized visual data, information and/or sometimes executable code that occupy tangible portions of nonvolatile memories storing information, privileges, parameters, profiles related to said users, companies or organizations enabling the execution of functionalities described in the present application.

This does not exclude that sometimes outputs, data and even executables may be stored, at least temporarily on volatile memories.

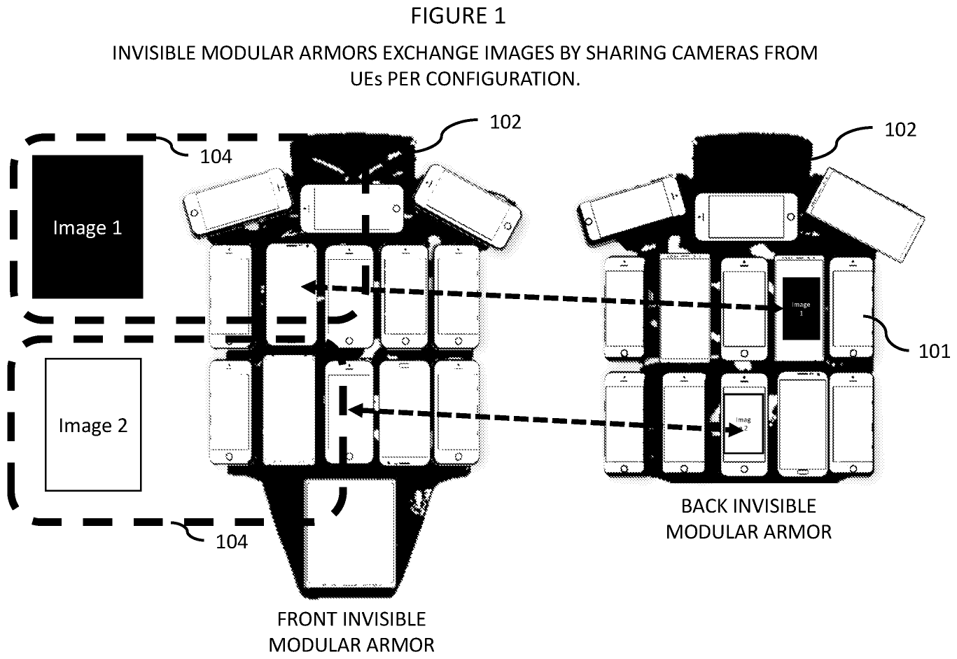

101 (UE) User Equipment—In one embodiment of the invention, UE are Mobile Phones devices, Personal Computers devices, Smart Phones devices, e-wearables devices (ex. AppleWatch, Fitbit bracelet), displays (ex. ELD, LCD, LED, PDP, QLED, OLED, AMOLED), smart glass, flexible devices, flexible screens, cameras, and/or portable electronics devices with standard online and offline features with or without cameras and displays that have been enhanced with the invention to create any method of modular invisible covers comprising of aggregating multiple devices into physical meshes and virtual networks where devices exchange multi-source data transactions and multiple transmissions between meshed devices to project on their respective screens the exchanged images and/or visual adjustments to produce multiple video stream “See-Through” effects via redundant self-correcting Video Stream Exchanges 104. Each and any User Equipment can be upgraded with a unique Modular Layer System 105, standard Modular Layer System 105, or no Modular Layer System 105 at all. User Equipment can be applied to Modular Body Armors 102, Invisible Cloaks 103, drones for wall formations 109, crafts 110, and layered upon another User Equipment for redundancy, power, and/or additional protection. It is assumed that a UE contains an embodiment of the invention or can access an embodiment of the invention via an interactive user interface (mobile app, browser, desktop app, etc. . . . ) in order to appreciate the benefits of the invention from FIG. 1 to FIG. 24. Although some embodiments of the invention may be uniquely fabricated UE 101 to improve the invisibility effect (ex. custom bracer device with smooth display), the general purpose of the invention is to stay modular to gain the benefits of modularity, redundancy, six sigma “poka yoke” user-friendliness, economies of scale, environmentally friendly (ex. corporate OSHA standards met by the majority of standard smart devices), enhance-ability (ex. LifeProof iPhone Cases to quickly waterproof enhance any UE up to 100 feet underwater), upgradability (ex. the software functions on new iPhone iOS platforms or the upgrades of the new Androids platforms), cross-platform (Video Streams works on the Apple Platform, Android Platform, and Linux), backwards compatibility (ex. the software functions on older iPhone iOS platforms and works on older Androids platforms), and/or quick repurposing (ex. taking UE from a vehicle to repair personal body armors with the UE). Due to noisy nature of war activities, Active noise control (ANC) technologies, also known as noise cancellation, or active noise reduction (ANR) can be implemented reduced unwanted sound by the addition of a second sound specifically designed to cancel the first. Sounds are pressure waves, consisting of alternating periods of compression and rarefaction, which can be countered with the UE's speakers, the UE's voice receivers, and/or other enhancements.

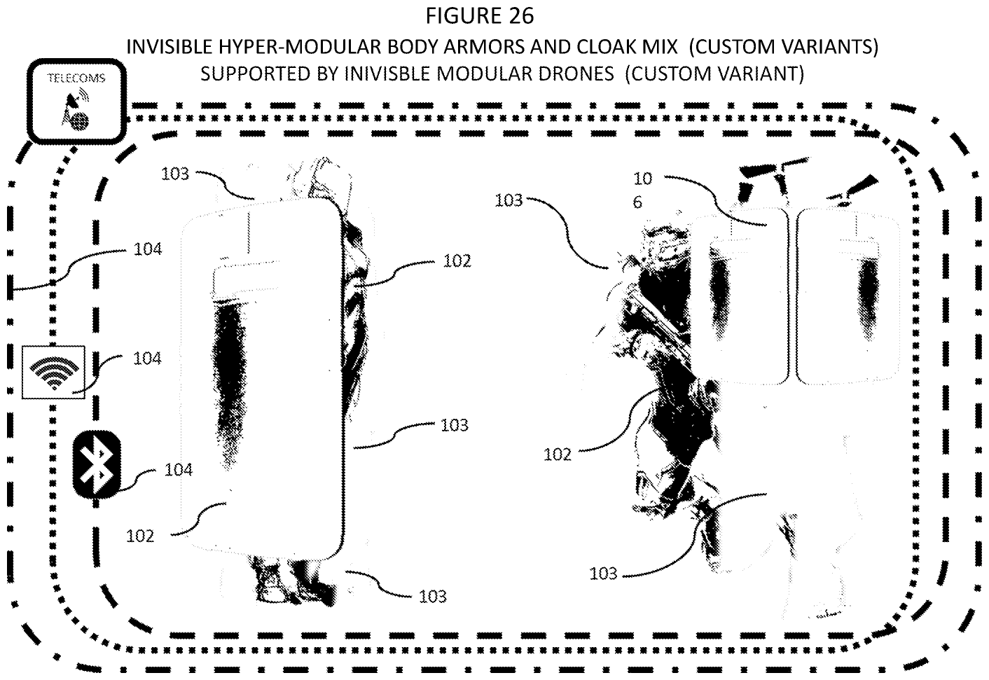

102 Invisible Modular Body Armor—In one embodiment of the invention, invisible body armors are modular invisible covers modified as protective clothing enhanced with UE 101 and a version of the modular layer system 105, in order to absorb, stop, and/or deflect slashing, bludgeoning and penetrating attacks. Body armors have historically been used to protect military personnel, whereas today, body armors are also used to protect various types of police (riot police in particular), private citizens, private security guards or bodyguards. In our modern world, there are two main types: regular non-plated personal armor (used by the use-cases mentioned above, except combat soldiers) and hard-plate reinforced personal armor, which is used by combat soldiers, police tactical units, private citizens, and hostage rescue teams. Depending on configuration and style, body armors can include helmets (without and without helmet mounts), shields, bracers, and/or other armor upgrades. These items can be enhanced with a variety of different User Equipment 101. Although some embodiments of the invention may be uniquely fabricated UE 101 to improve the invisibility effect (ex. custom bracer device with smooth display), the general purpose of the invention is to stay modular to gain the benefits of modularity, redundancy, six sigma “poka yoke” user-friendliness, economies of scale, environmentally friendly (ex. corporate OSHA standards met by the majority of standard smart devices), enhance-ability (ex. LifeProof iPhone Cases to quickly waterproof enhance any UE 101 up to 100 feet underwater), upgradability (ex. the software functions on new iPhone iOS platforms and works on new Androids platforms), backwards compatibility (ex. the software functions on older iPhone iOS platforms and works on older Androids platforms), and/or quick repurposing. At the most basic level, in FIG. 1, a User 107 can manually activate each UE 101 with a plurality of commercial video call applications (ex. Skype mobile app, Skype for Business mobile app, WhatsApp mobile app, FaceTime mobile app, WebEx mobile app, etc. . . . ), to create the basic “See-Through” effect, but this “Civilian App” configuration and deployment is manual, time consuming, and/or not designed for invisibility; therefore, the lack of redundant self-correcting Video Stream Exchanges (rscVSE) 104, Modular Layer System 105, and/or Invisibility Administration Portals 108 to create Invisible Combined Arms Actions 111 will restrict this functional yet limited basic “Civilian App” invisibility configuration. In repair user case of repurposing, where a user with a shield enhance with UE 101 can separate the UE 101 from the shield and then quickly re-meshed those UE 101 to repair a comrade's personal body armor enhanced with UE 101. Upon repair, the new UE 101 mesh resynchs with the invisible body armor to regenerate a new redundant self-correcting Video Stream Exchanges 104. Uniquely-fabricated UE 101 are specialized items and may be required in some cases. However, the modular body armors can consist and can be mixes of uniquely-fabricated UE 101 and general commercial UE 101 (ex. iPhones, Android phones, iWatches, etc. . . . ). The fixturing (ex. basic Velcro trap, reinforced clip-on, industrial zip-ties, etc. . . . ) to attach the UE 101 to the modular body armors will be different per configuration per body armor due to the nature of body armor industry and the differences sizes between human beings. In addition, configurations for equipment trading are optional and adjustable. Thus, users that trade armor shields enhanced with UE 101 in the middle of a battle and sync to their new body armor of the new user's configurations for the redundant self-correcting Video Stream Exchanges 104 to function based on secured command (ex. voice command, physical motion, 5-digit pin on GUI, etc. . . . ). FIG. 1, 2, 8, 10, 11 through 16, 20, and 24 provide some examples of Invisible Modular Body Armor types. FIG. 26 shows Invisible Hyper-Modular Body Armors, which are the same as regular Invisible Hyper-Modular Body Armors in scope and methods; with the exception that Invisible Hyper-Modular Body Armors had several iterations of miniaturization of the UE 101 and incremental improvements due to current miniaturization trends in last 100 years on other computer components, such as transistors, CPUs, GPUs, RAM, ROM, and more. Miniaturization of the UE 101 will increase the amount of endpoints, cameras, routes, ip addresses, VLANs, trunks, port security handling, and other objects and elements to track, provision, license, and manage; which can be handled by modern Manager-Of-Manager (MOM) software, such as a modified version of Cisco Host Collaboration Solutions (HCS), which instead of handling Dial Plan Workflows and managing and connecting hundreds of thousands of civilian smart devices into networks of telepresence for meetings, work collaboration, sales calls. For FIG. 26, the modified HCS-style MOM software would track redundant self-correcting Video Stream Exchanges (rscVSE) 104, invisibility configurations to endpoints, and focus on Invisible Combined Arms Actions 111.

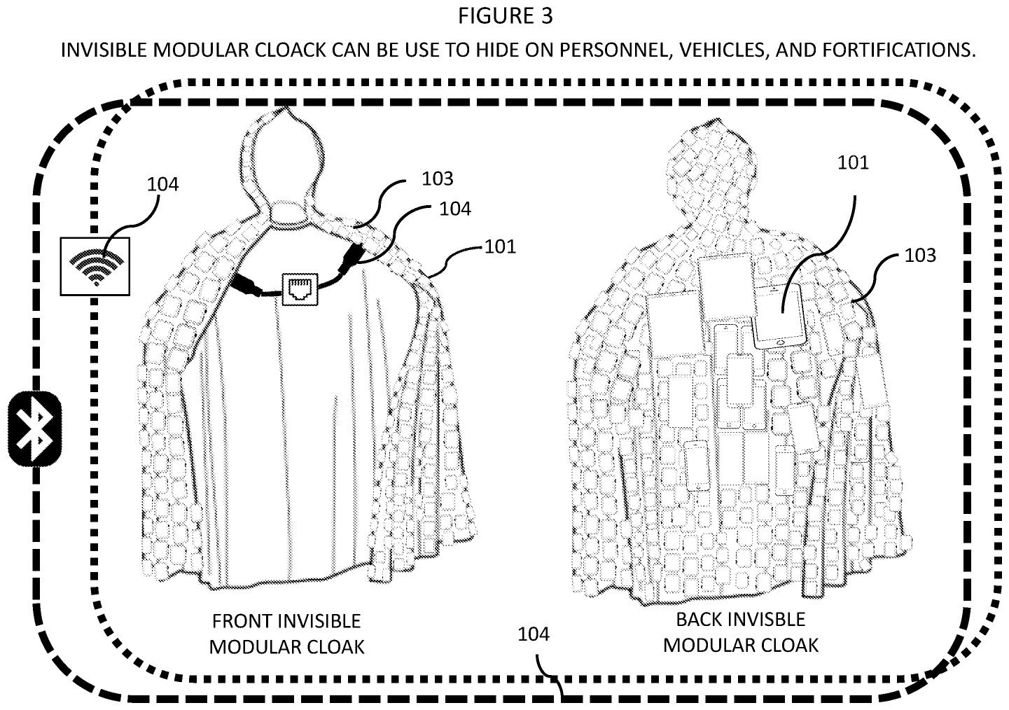

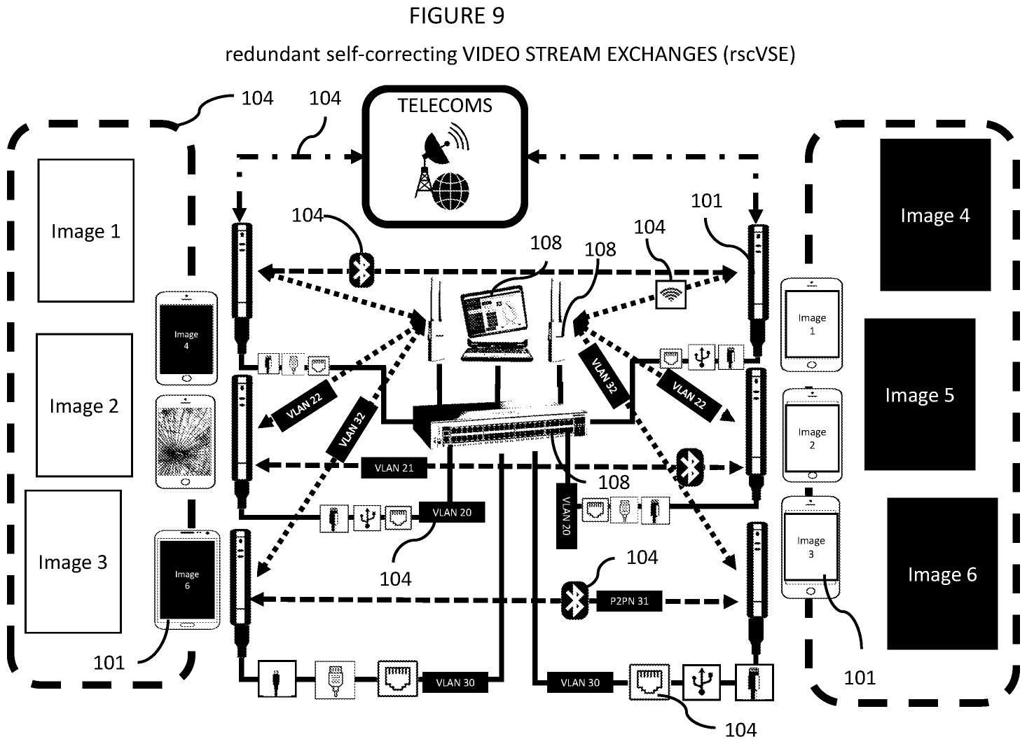

103 Invisible Modular Light Cloak—Invisible Modular Light cloaks are similar to the concept of modular body armors 102. The exception is that focus on invisibility and concealment over protection of human life based on the configuration of the modular layer system 105. In addition, a user may wish to equip themselves with both a modular light cloak and a modular body armor 102. Modular light cloaks can be used on mobile equipment, hide supplies, and/or perhaps provide concealment to stationary aircraft; among the many uses. Modular light cloaks may have power cords and/or multiple power adapters to connect with local power types formats (ex. v120, v240, D/C, A/C), car batteries, vehicle alternators, and/or mobile power generators. In some deployments, modular light cloaks can daisy-chain with each other not different than connecting Christmas lights on civilian housing and civilian stores. However, these connections can and should be easy to disconnect and power, which is where the modular light cloaks UE's modular layer system 105 can be configure with a batter energy layer, such as a combination of FIG. 3 and FIG. 9 with wireless charging technology. Thus, introducing wireless charging technologies into modular light cloaks can reduce personnel accidences (ex. no tripping over cords; no electrocutions due to protected electric charge transfer), improve compliance with OSHA standards, speed up invisibility deployments, and focuses on the principles of military safety.

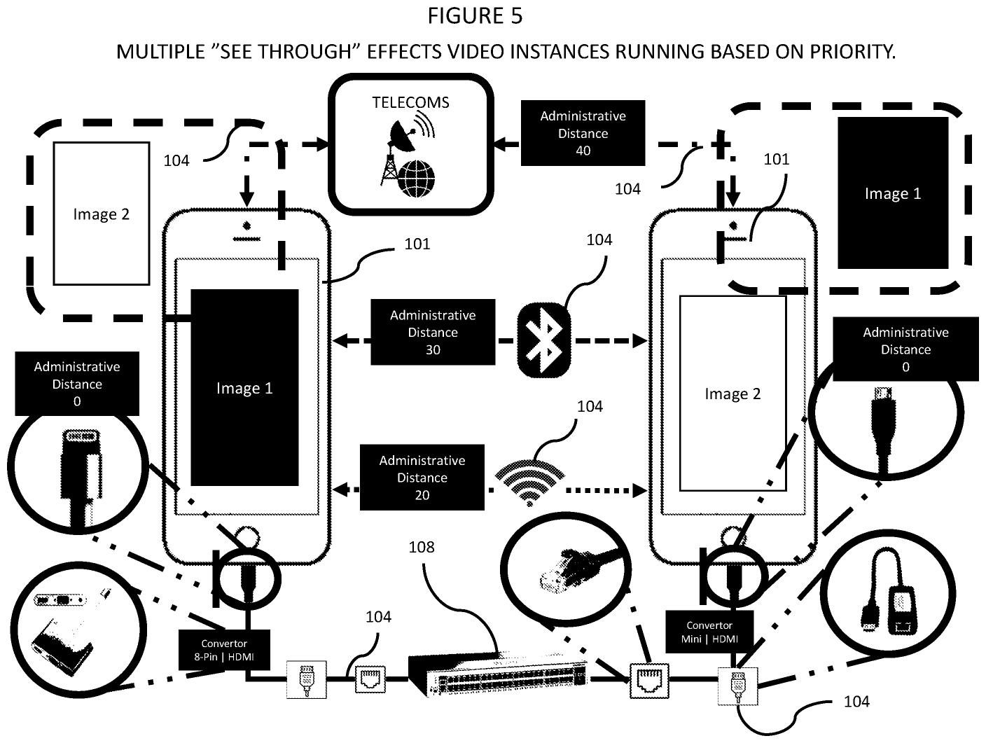

104 redundant self-correcting Video Stream Exchanges (rscVSE)—In one embodiment of the invention, redundant self-correcting Video Stream Exchanges data by aggregating a plurality of User Equipment 101 into physical meshes and virtual networks where User Equipment 101 exchange multi-source data transactions, streams, and transmissions between meshed User Equipment 101 to project on their respective displays the exchanged images and/or visual adjustments to produce multiple video stream “See-Through” effects between meshed User Equipment 101 as illustrated FIGS. 1 to 25. Depending on access, Invisible Local Users 106 and Invisible Administrators 107 can use their respective User Equipment 101 and/or Invisibility Administration Portal 108 to configure these exchanges. These methods are self-correcting due to User Equipment 101 supporting other User Equipment 101 with their respective cameras on User Equipment 101 that are damaged, installed incorrectly (‘poka yoke’ philosophy) where the camera lenses are covered, displays are placed backward, lags, a User Equipment 101 detaches from mesh due to Body Armor 102 malfunction, and/or other scenarios. The self-correcting Video Stream Exchanges can be distributed by the UE 101 using multiple technologies, such as Bluetooth, Wi-Fi, Ethernet, Telecom's LTE wires, 8-pin connectors, and/or other wireless and wired technology in order to create redundancy and quality assurance. As part of instant availability as shown in FIG. 5, the UE 101 can initiate several video streaming instances 104 and running those streams, pre-fabricated sessions, in parallel within the UE 101; and upon a trigger, such as a damaged directly Ethernet line with an administrative distance of 0. When upon the trigger set (ex. pixelation table with level), where (based in configured selection logic [Admin Distance]), in the case of FIG. 5, the Wi-Fi video stream will be selected next, and thus, beginning displaying the video stream instance in the UE 101's display, while deactivating the Ethernet video streaming instance and mark the port for repair in the invisibility portals 108. In FIG. 9, the invisibility configuration shows a damaged UE 101 with a damaged camera and how the other UE 101 perform exchange the video streams 104, whether pre-running instance or freshly activated instances, in order to share images and compensate for the damaged UE 101. In addition, due to the nature of multiple cameras and triangulation points via GPS, these exchange between the User Equipment 101 can be improved with AI learning and react to changes user updating the configuration using a portal 108. Other features to integrate with multiple cameras are any targeting system to detect and react when required by Invisible Combined Arms Actions 111. The hierarchy and sorting methods to select, exchange, and correct video streams and video stream instances can be segregated in tiers (ex. Administrative Distance, Manually Order, etc. . . . ), access levels (ex. Local User vs. Invisibility Administrator), and sorting methodologies (ex. comparison sort, non-comparison sort, pivot sort, LIFO, FIFO, etc. . . . ) per configuration, parameters, and triggers as set by the invisibility administrator 107 via the portal 108. The video streams and back-up instances can be block chained and/or encrypted in regular formats (SSH, SCP, MD5, etc. . . . )

105 Modular Layer System—In one embodiment of the invention, layer features that can be implemented in each and any User Equipment 101 to enhance and sustain the capacity of the “See-Through” video streams with traditional power sources (ex. batteries), air conditioning/thermal capabilities (ex. heat sinks, thermal paste, pumps, coolants, coils), X-ray neutralizing capacity (ex. high-density lead alloy), armor implementations (ex. titanium layer, galvanize steel), multi-camera add-ons, dual-sided display devices (ex. 2 smart devices per UE 101), element-resistance (ex. water, lighting, ice, and fire), solar re-energizing, bullet-proof glass (ex. plexiglass), wireless charging technology mods, smoke deployments, advanced polymers, and/or other unique enhancements. The systems can work in unity or separate from another User Equipment 101 depending on configurations and access levels on the software. Synchronization should happen between devices as determined by the users and the feature layers are modular with simple mechanisms (ex. pull and lock, clip-on, Velcro, mount) in order speed up repair and repurposes quickly, such as the user replacing an obsolete battery and/or upgrading an armor layer (ex. basic steel to threated titanium) in less than 5 steps and a simple crew driver. In watercraft invisibility implementations, additional layers, whether internal or external, can be added sustain the system's invisibility functionality, such as stopping salt corrosion on the UE 101; and hide, absorb, and/or counter for sonar pulses signals from enemy ships via aquatic Active noise control (ANC) from water-proofed UE 101.

106 Invisibility Local User—In one embodiment of the invention, the individuals using and/or interacting with Invisible Modular Body Armor 102, Invisible Modular Light Cloak 103, and other modular invisible compositions. These users can change the local configurations within their respective access to the configurations of the Invisible Modular Body Armor 102, Invisible Modular Light Cloak 103, and other modular invisible compositions via any User Equipment 101 with that access. The configuration creation is done within Invisibility Administration Portals 108 with access as an Invisibility Administrator 107.

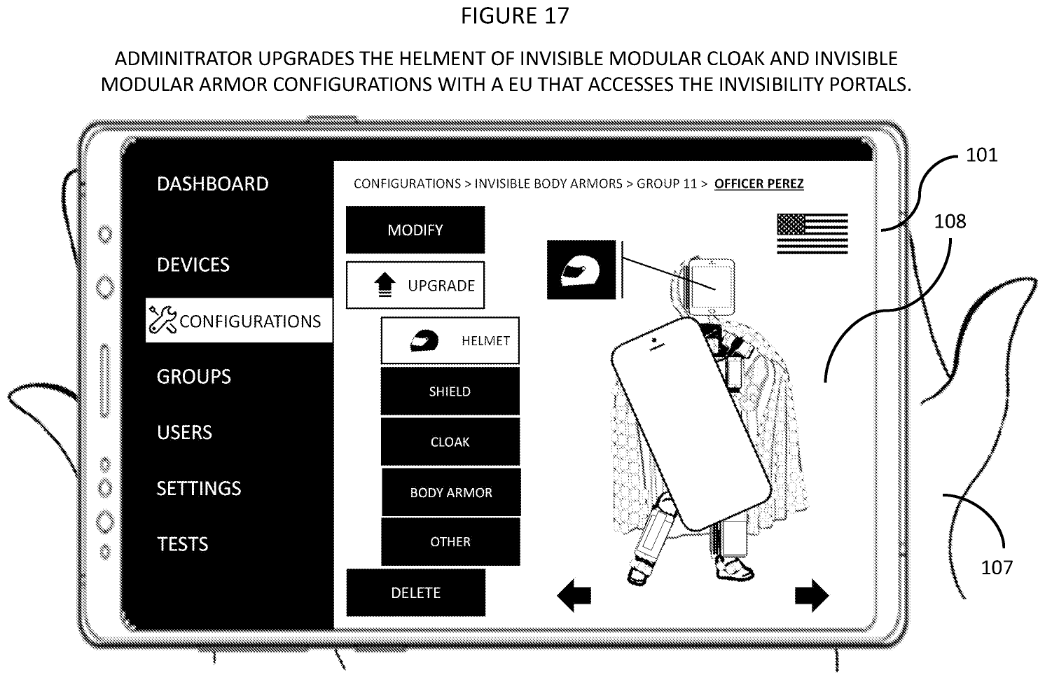

107 Invisibility Administrator—In one embodiment of the invention, the individuals using and/or interacting with 102 Invisible Body Armor 102, Invisible Modular Light Cloak 103, and other modular invisible compositions; and how also have administrator rights to use the Invisibility Admiration Portals 108. FIG. 17 shows an Invisibility Administrator using an embodiment of the Invisibility Administration Portals.

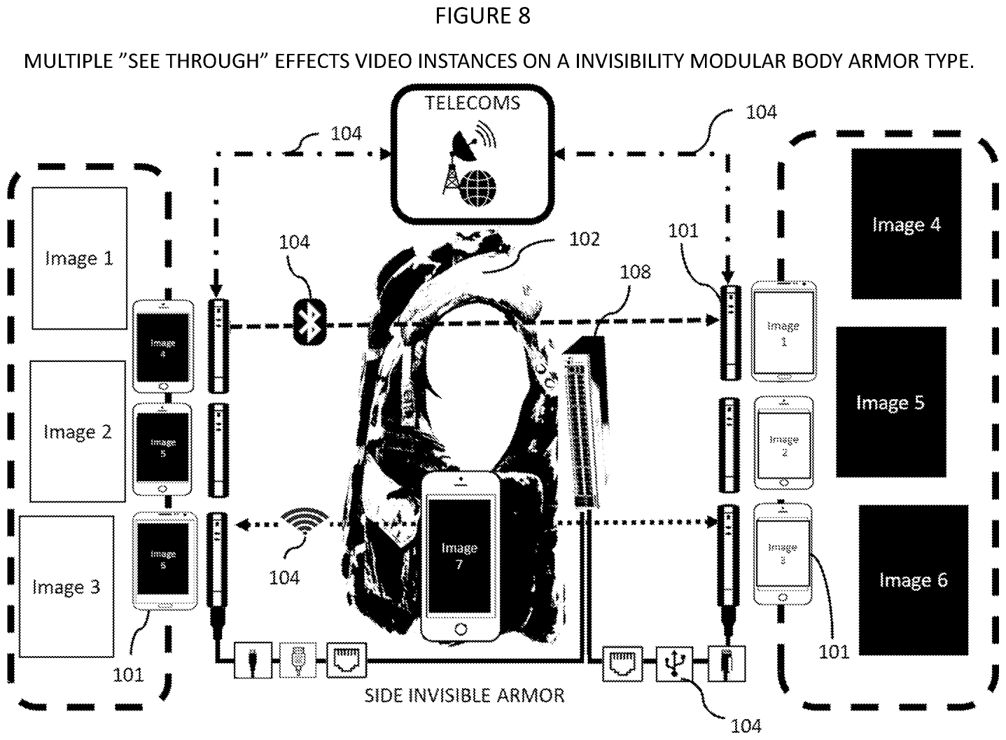

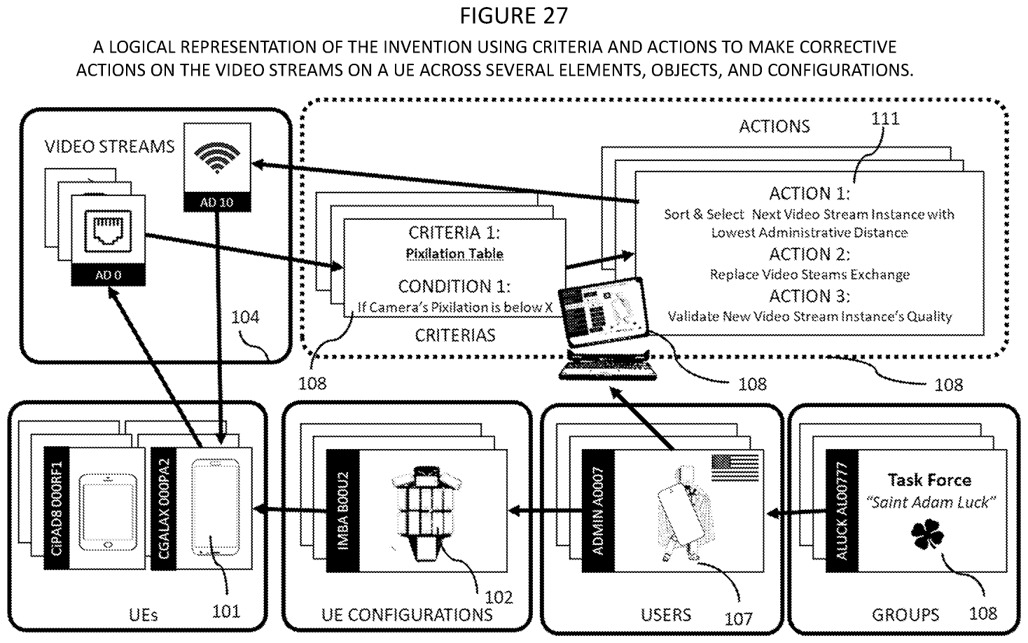

108 Invisibility Administration Portals—In one embodiment of the invention, Invisibility Administration Portals are invisibility administration management software module for Invisibility Administrators 107 with the focus on managing redundant self-correcting Video Stream Exchanges (rscVSE) 104 configurations and Invisible Combined Arms Actions 111. With this module, the Invisibility Administrators can create, manage, modify, upgrade, close, and/or delete invisibility configurations, groups, users, settings, and/or devices. FIG. 17 is a visual demonstration of Invisibility Administrator 107 upgrade a User's 106 invisible helmet variant using a version of the Invisibility Administration Portals. If desired the software, application logic and/or hardware may reside on a UE 101, part of the application logic and/or hardware may reside on segregated servers from the Data Lakes, part of the application logic and/or hardware may reside in the Data Lakes environments, part of the application logic and/or hardware may reside in the external environments, part of the software, application logic and/or hardware may reside on hosted environments, and part of the software, application logic and/or hardware may reside on distributed in a P2P network with or without blockchain technology enhancements. Using P2P network within the UE 101 for routing management and video distribution, Users 106 using UE 101 can decouple from external networks (ex. telecoms) without suffering quality issues associated with normal interferences, such as large buildings and underground environments. These portals setup and manage the basics of a networks from Domain Server, NAT server, DHCP server, Active Directory, router, switching, streaming, frameworks, secure protocols, and other functions to ensure that any invisibility configuration can be deployed. FIG. 8 is a variant of the invention where all UE 101 has multiple connections and 48 port switch devices can connect to 48 smart devices can use converters. In that case, the UE 101 pair connect using an 8-pin to USB, USB to Ethernet, Ethernet switch port, VLAN connect protocols, Ethernet switch port to Ethernet, Ethernet to USB converter, and finally, USB 8-point converter to other device using IPv4 protocols. Thus, the UE 101 coupling avoids the distance and problems of choppy wireless MB Telcom2Telcom communication. Instead, now, the UE 101 coupling has a direct Ethernet CAT-6 10 GB line with an Administrative Distance of 0. FIG. 9 is a layout of example of a mobile portal device deployment can be a 12 multi-4 Gz-cores ‘Toughbook’-style laptop with a premium SSD, a 4 GB graphics card, and extend battery pack, whose cores have been virtualized via VMware to create a MS Server 2016 Standard environment to provide all functions (NAT, DHCP, Domain, Router function, etc. . . . ), install the inventions' modified version of video manager that controls the redundant self-correcting Video Stream Exchanges (rscVSE) 104, and attaching an Ethernet cable to a top of the line PoE wireless access point (WAP) to connect nearby Invisible Modular Body Armor 102, Invisible Modular Light Cloak 103, Invisibility Local User 106, Invisibility Modular Drones 109, 110 Invisible Modular Craft Armor, and other items with UE 101 to begin Invisible Combined Arms Actions 111. Ideally, all devices are connected multiple sources of video distribution (Telecoms, Bluetooth, Wi-Fi, etc. . . . ), which can be created by adding additional NICs, ports, and MAC addresses, whether physical and/or virtual. A limited modified version of these portals is provided to the Local Users 106 in order to perform actions within their invisibility scope and for security purposes. FIG. 26 shows Invisible Hyper-Modular Body Armors, which increase the amount of endpoints, cameras, routes, IP addresses, VLANs, trunks, port security handling, sensors, GPS coordinates, and other objects and elements to track, provision, license, and manage; which can be handled by modern Manager-Of-Manager (MOM) software, such as a modified version of Cisco Host Collaboration Solutions (HCS) for ISPs which handles thousands of Dial Plan Workflows; managing and connecting hundreds of thousands of civilian smart devices into networks for telepresence, corporate meetings, work collaboration, sales calls, PBXs, LANs, WANs, instant messaging, and more. For FIG. 26, the modified HCS-style MOM software portals would track millions of redundant self-correcting Video Stream Exchanges (rscVSE) 104, thousands of invisibility configurations with millions of endpoints as show in FIGS. 1 to 26 for millions of Users 106, and focus executing thousands of Invisible Combined Arms Actions 111. FIG. 27 is a simplified logical workflow of the concepts mentioned to show that the Invisibility Administrator 107 can set the criteria, conditions, and/or actions with a portal to trigger video stream changes when executing redundant self-correcting Video Stream Exchanges (rscVSE) 104.

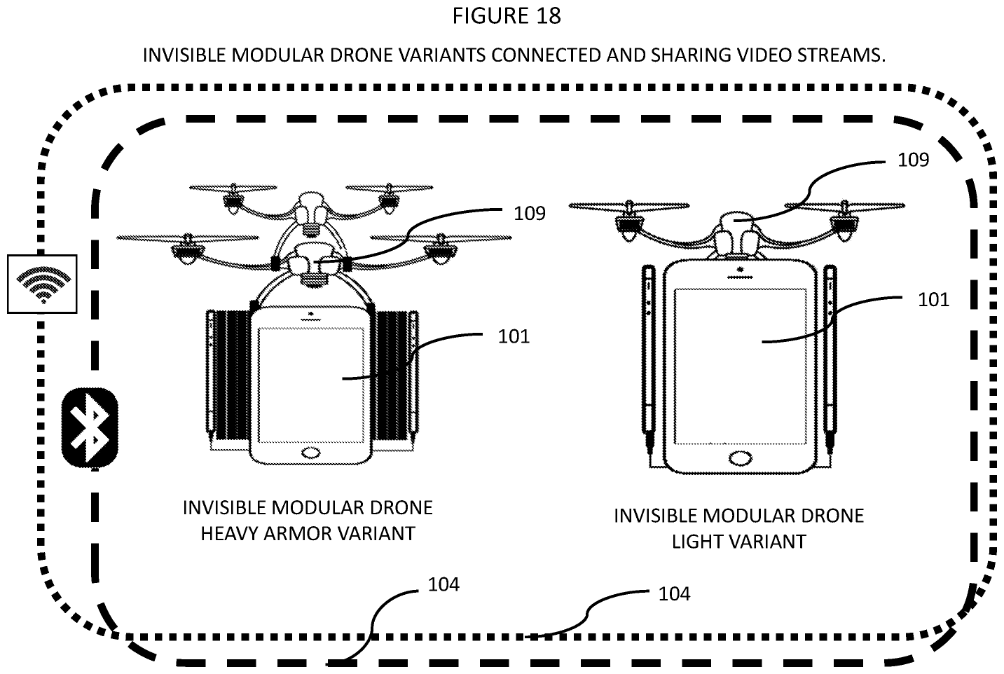

109 Invisibility Modular Drones—In one embodiment of the invention, invisibility modular drones can be custom flying drones and/or commercial drones equipped with the User Equipment 101 to create video stream exchanges 104. The drones can be configured in the invisibility administration portals 108 to include swarm software automation between drone configuration and/or manual control of each drone by a human user piloting via remote access. Drone walls 111 can be created, and can proximity synchronize with Invisible Modular Body Armor 102, Invisible Modular Light Cloak 103, Invisibility Local Users 106, and other modular invisible compositions. Due to the proximity of drone wall formations 111, local drones can share and daisy chain wireless technologies, such as Bluetooth (normal has limited range) and WiFi, and thus, the drones can communication hop between each other. These means that a drone 1 can communicate with a drone 2, which is 100 feet away, as long as there as enough drones and other equipment with UE 101 (Invisible Modular Body Armor 102, Invisible Modular Light Cloak 103, Invisibility Local User 106, and other modular invisible compositions) in between drone 1 and drone 2 to carry the Bluetooth and/or WiFi signals to perform redundant self-correcting Video Stream Exchanges (rscVSE) 104. FIGS. 18-21, 23, and 25-27 show difference version, styles, uses, criteria, actions, and configurations for invisible flying drones, which are ideal for Invisible Combined Arms Actions 111.

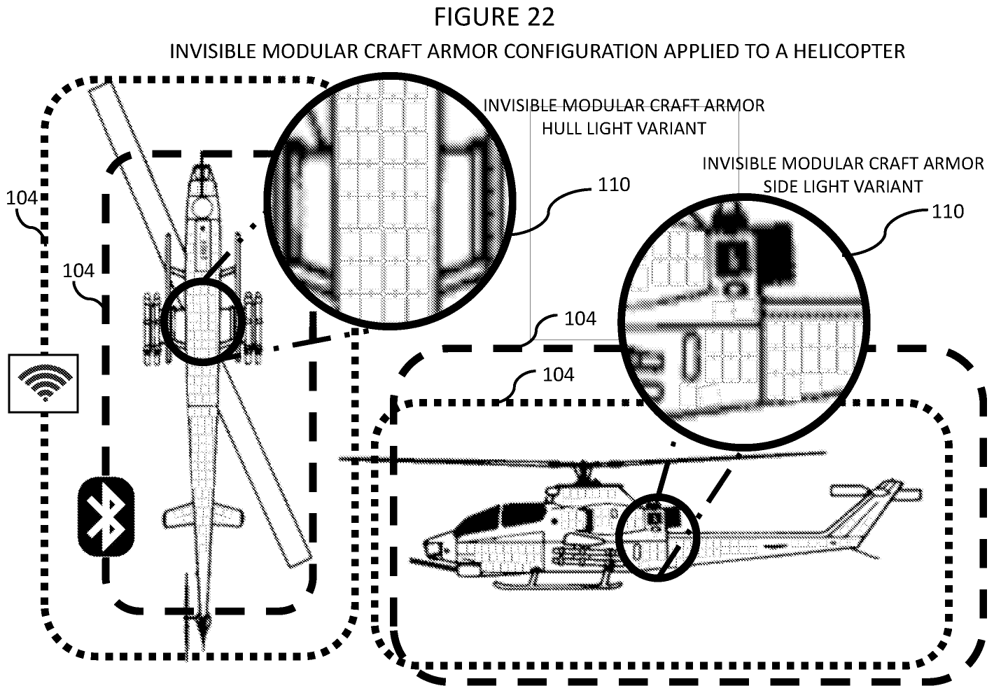

110 Invisible Modular Craft Armor—In one embodiment of the invention, Invisible Module Craft Armor is the same as the Invisible Modular Body Armor 102, which the exception that the armor is design for moving, floating, and/or flying vehicles. Thus, the requirements and installation will change when an invisible modular craft armor travels at 300 miles per hour, a mile underwater, and/or experiencing 10 g-forces in space. The changes will be added to the Layer Modular System 105, improved attachments, welding, specially designed UE 101, targeting systems, and/or even, OEM to the initial craft to meet engineer specifications. FIGS. 22 to 25 show different versions, uses, and scenarios of some embodiments of Invisible Modular Craft Armor. Targeting Systems can be enhanced by the numbers of cameras and shared cameras used in the video stream exchanges 104 to generate new Invisible Combined Arms Actions 111. In watercraft invisibility implementations 110, additional layers in the Modular Layers Systems 105, whether internal or external, can be added sustain the system's invisibility functionality, such as stopping salt corrosion on the UE 101; and hide, absorb, and/or counter for sonar pulses signals from submarines via aquatic Active noise control (ANC) from water-proofed UE 101.

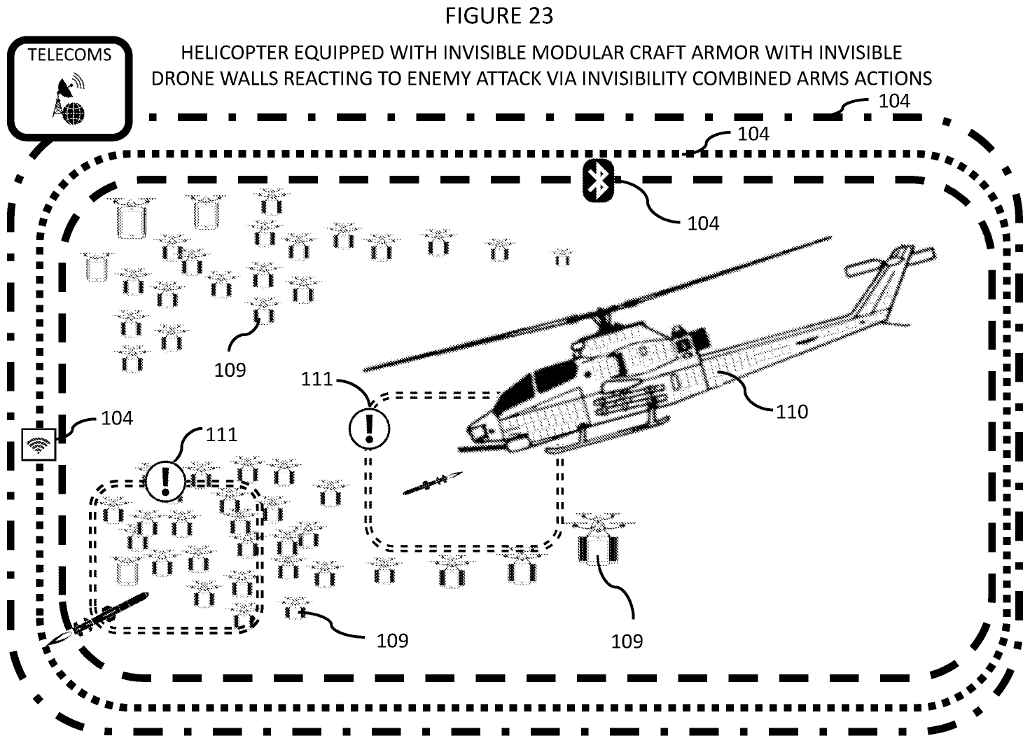

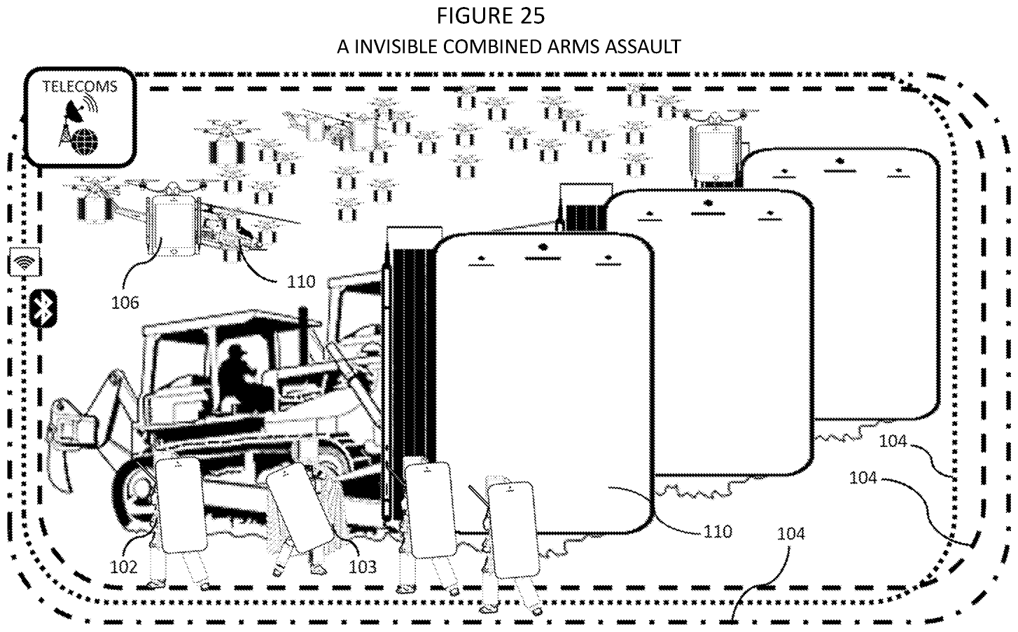

111 Invisible Combined Arms Actions—In one embodiment of the invention, Invisible Combined Arms Actions can consist of the coordination between Invisible Modular Body Armors 102, Invisible Modular Cloaks 103, Invisibility Modular Drones 109, connected UE 101, and/or 110 Invisible Modular Craft Armors to act together to perform a configuration upon a trigger, such an enemy attack, friendly forces advancements for repositioning, tactical retreats, and/or other strategic and tactical maneuvers as setup in the Invisibility Administration Portals 108. FIG. 23 demonstrate a defensive example would be a helicopter equipped with Invisible Modular Craft Armor 110 that is surrounded with a radius of 100 yards by a swarm wall of Invisibility Modular Drones 109. Upon attack, the Invisibility Modular Drones 109 and Invisible Modular Craft Armor 110 work together to stop any damage. Invisibility Modular Drones 109 can simply move in the way of any enemy attacks to save the crew of the helicopters with Invisible Modular Craft Armor 110. Due to the discrepancy of helicopter turbine power versus simple drone 109 propellers, the invisible flying wall formations of invisible modular drones 109 will likely be implemented as invisible defensive postures; slow invisible infantry support; and/or invisible helicopter take-offs and arrivals to helipads to hide and/or protect the helicopters during hovering exposure, but with enough distance to stop any UE 101 from becoming safety hazard to the helicopter and the crew. Such safety enhancements can be programmed 108. In addition, due to the nature of sharing cameras between UE 101, developers with administration access 107 can link this feature to the defense and attack systems of any craft, in this example, a helicopters' defense flying wall defenses and a counter anti-missile defense system. Some API can be added to the administration portals 108 for such enhancement. The invention can have methods to correct camera problems, such as damages. This correction allows the other devices to send and collect the video stream 104 from other devices and pick the best video to stream 104; and/or create a new image based on the images from other cameras when several cameras from those UEs 101 share and process the best video stream to be transmitted. This system 108 of video image correction 104 will be critical in a case of fast-moving crafts, such as helicopters, airplanes, spacecraft, etc. . . . . These problems are more obvious in Telcom2Telcom video streaming 104, which can be an UE 101 sending video stream to ISP 1 tower, ISP 1 tower to ISP 1 data center via Fiber, then to the next ISP 1 data center via Fiber to ISP 2 data center via Fiber, ISP 2 data center to ISP 2 tower, and finally, ISP 2 tower to second UE 101. In contrast in time and distance savings, a UE 101 can send a signal to another UE 101 via Wi-Fi and/or Bluetooth and reducing the data hops for the video exchanges 104. For that very reason, variants of the invention likely to require multiple methods to ensure multiple connections between different UE 101 to create mediums, such as Wi-Fi, Ethernet, Bluetooth, ISP Telcom, and other wired/wireless technologies to ensure redundancy, availability, and quality of services for video stream instances exchanges 104. The invisible modular craft armor 110 types can consist of different UE 101 types and it is assumed that the UE 101 can be a combination of generic commercial devices, custom commercial devices, smart e-wearables, and/or military-grade devices, whether custom and/or mass produced. FIG. 25 shows a large invisibility combine arms infantry support movement with civilian support using a plurality of some embodiments of Invisibility Modular Drones 109, Invisible Modular Craft Armors 110, Invisible Modular Body Armors 102, Invisible Modular Cloaks 103, and more, all in coordination.

### DETAILED DESCRIPTION OF THE DRAWINGS

An example embodiment of the present invention and its potential advantages are understood by referring to FIGS. 1 through 36 of the drawings.

FIG. 1 represents a simplified possible schematic embodiment of the invention describing the methods, system, and apparatus for an invisible personal body modular armor 102, which consist of the multiple smart devices (User Equipment—UE) 101 meshed on a basic body armor with groin protection. All UE 101 are connected transmitting video streams 104 to the polar-opposite UE 101 in order to create a “See-Through” effect. The invention can have methods to correct camera problems, such as damages. This correction allows the other UE 101 to send and collect the video stream 104 from other UE 101 and pick the best video to stream; and/or create a new image based on the images from other cameras, as shown with Image 1 and Image 2, when several cameras from those UEs 101 share and process the best video stream 104 to be transmitted. The armors 102 can consist of different UE 101 types and it is assumed that the UE 101 can be a combination of generic commercial devices, custom commercial devices, and/or military-grade devices.

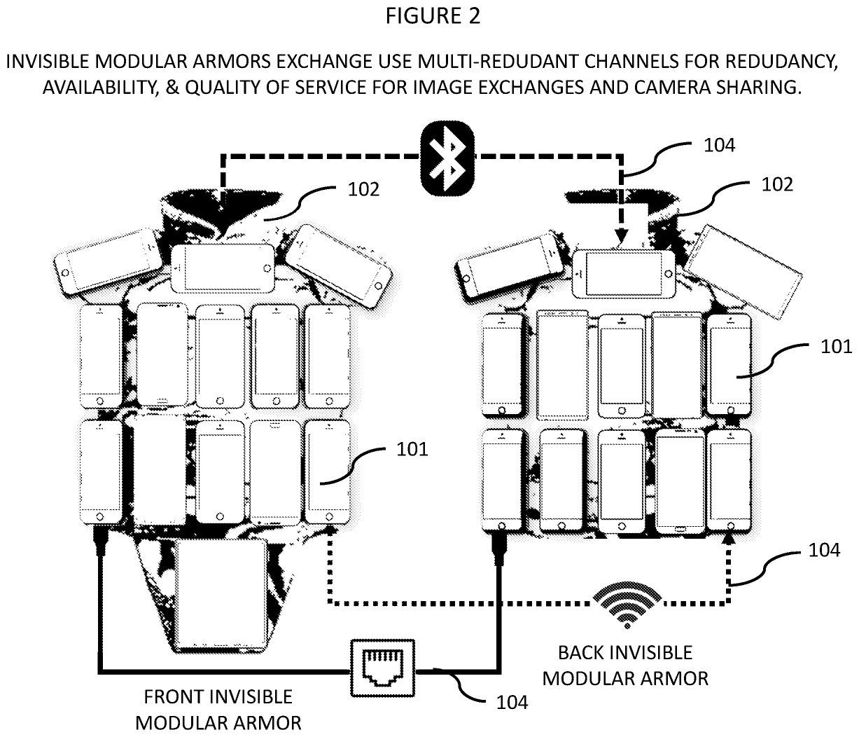

FIG. 2 represents a simplified possible schematic embodiment of the invention describing the methods, system, and apparatus for an invisible modular covers in a personal modular cloak armor 103 configuration, which consist of the multiple UE 101 meshed on a basic body armor with groin protection. All UE 101 are connected transmitting video streams 104 to the polar-opposite UE 101 in order to create a “See-Through” effect. The invention can have methods to ensure multiple connections between different UE 101 to create mediums, such as Wi-Fi, Ethernet, Bluetooth, and other wired/wireless technologies to ensure redundancy, availability, and quality of services for image video stream exchanges 104.

FIG. 3 represents a simplified possible schematic embodiment of the invention describing the methods, system, and apparatus for an invisible personal modular cloak type 103, which consist of the multiple UE 101 meshed to around a protective blanket netting. All UE 101 are connected transmitting video streams to the polar-opposite UE 101 in order to create a “See-Through” effect. These combinations UE 101 and separate configuration can and should harmonize and synchronize to ensure the quality of the “See-Through” effect using image video stream exchanges 104. The invention can have methods to ensure multiple connections between different UE to create image video stream exchanges 104, such as Wi-Fi, Ethernet, Bluetooth, and other wired/wireless technologies to ensure redundancy, availability, and quality of services. The invisible modular cloak types can consist of different UE 101 types and it is assumed that the UE 101 can be a combination of generic commercial devices, custom commercial devices, and/or military-grade devices.

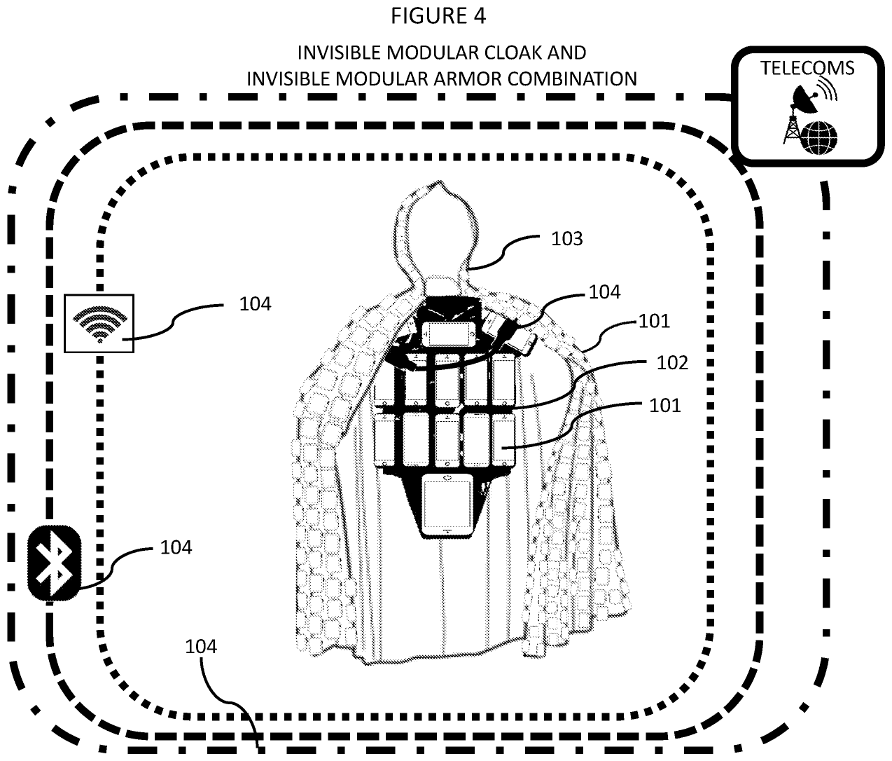

FIG. 4 represents a simplified possible schematic embodiment of the invention describing the methods, system, and apparatus for mix combination of an Invisibility Modular Cloak 103 type, which consists of the multiple UE 101 meshed to around a protective blanket netting surrounding an Invisibility Modular Body Armor 102 type with groin protection enhanced with UE 101. All UEs are connected transmitting video streams to the polar-opposite UE 101 in order to create a “See-Through” effect using image video stream exchanges 104. The invention can have methods to ensure multiple connections between different UE to create image video stream exchanges 104, such as Wi-Fi, Ethernet, Bluetooth, and other wired/wireless technologies to ensure redundancy, availability, and quality of services. The Invisible Modular Armor 102 type and Invisibility Modular Cloak 103 types can consist of different UE 101 types and it is assumed that the UE 101 can be a combination of generic commercial devices, custom commercial devices, and/or military-grade devices.

FIG. 5 represents a simplified possible schematic embodiment of the invention describing a system implementation of the two smartphone UE 101 sharing images and video streams between two polar-opposite UE to create and illustrate a simplified “See-Through” Effect via video image exchanges 104. The invention can have methods to ensure multiple connections between different UE 101 to create video stream mediums, such as Wi-Fi, Ethernet, Bluetooth, ISP Telcom, and other wired/wireless technologies to ensure redundancy, availability, and quality of services for image exchanges 104. In this example, the two UE 101 can 10 GB/s stream video content by Ethernet connection 104 using a mix of converters, USB cords, HDMI cables, Mini-USB, 8-pin adapter, straight-through Ethernet 10BASE-T cables and a smart layer 3 switch with 10 GB/s ports, which can be part of an invisibility portals 108. In this example, each video stream medium 104 has an associate Administrative Distance per digital route in order to setup video stream priority when different digital routes begin to fail intentionally (ex. battle damage) and/or unintentionally (ex. operator error of removing an Ethernet cable).

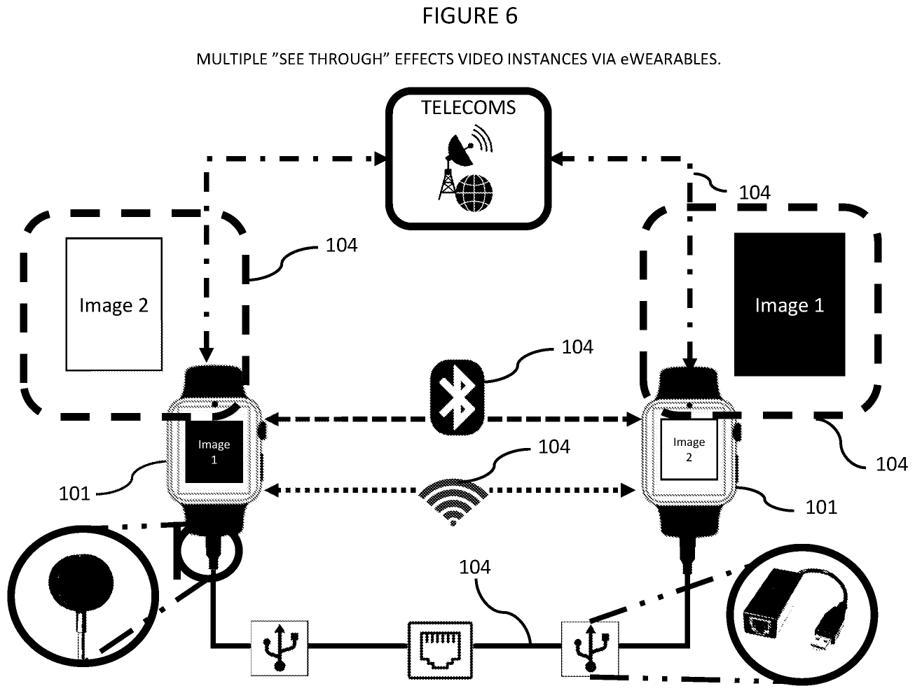

FIG. 6 represents a simplified possible schematic embodiment of the invention describing a system implementation of the two smart e-wearables UE 101 sharing images and video streams between two polar-opposite UE 101 to create and illustrate a simplified “See-Through” Effect via video image exchanges 104. The invention can have methods to ensure multiple connections between different UE 101 to create video stream mediums 104, such as Wi-Fi, Ethernet, Bluetooth, ISP Telcom, and other wired/wireless technologies to ensure redundancy, availability, and quality of services for video exchanges 104. In this example, the two UE 101 can 10 GB/s stream video content by Ethernet connection 104 using a mix of converters, wireless Apple Watch Magnetic Charging Cables, USB cords, and crossover Ethernet 10BASE-T cable, which can directly integrate UE 101 and managed indirectly via the invisibility portal 108. The invisible modular armor types can consist of different UE 101 types and it is assumed that the UE 101 can be a combination of generic commercial smart e-wearables, custom commercial smart e-wearables, and/or military-grade smart e-wearables.

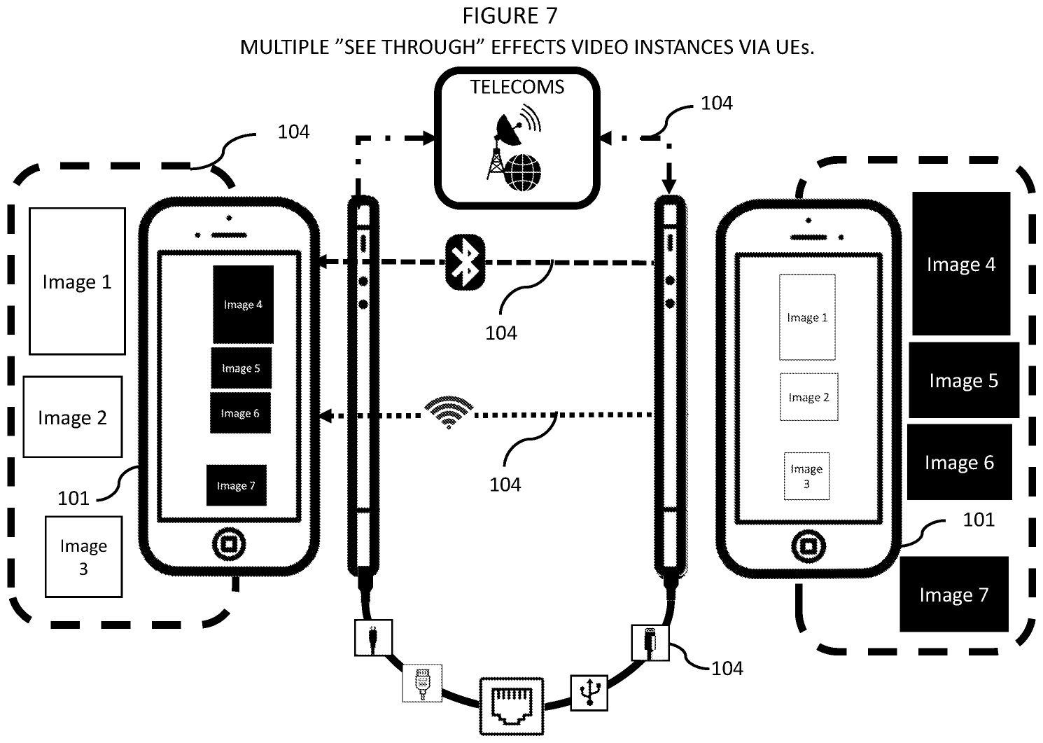

FIG. 7 represents a simplified possible schematic embodiment of the invention describing a system implementation of the two smart devices UE 101 sharing images and video streams 104 between two polar-opposite UE to create and illustrate a simplified “See-Through” Effect via video image exchanges 104. The two UE 101 are placed back to back to illustrate a side view of the “See-Through” Effect. The invention can have methods to ensure multiple connections between different UE to create video stream instances 104, such as Wi-Fi, Ethernet, Bluetooth, ISP Telcom, and other wired/wireless technologies to ensure redundancy, availability, and quality of services for video exchanges 104. In this example, the two UE 101 can 10 GB/s stream video content by Ethernet connection 104 using a mix of converters, USB cords, HDMI cables, Mini-USB, 8-pin adapter, USB cords, and crossover Ethernet 10BASE-T cable, which can directly integrate UE 101 and managed indirectly via the invisibility portal 108.

FIG. 8 represents a simplified possible schematic embodiment of the invention describing a system implementation of the multiple smart devices UE 101 on a personal body armor and sharing video image streams 104 between multiple polar-opposite UE 101 to create and illustrate a simplified “See-Through” Effect via video image exchanges 104 to create an Invisible Modular Body Armor 102. The multiple UE 101 are placed back to back to illustrate a side view of the “See-Through” Effect. The multiple UE 101 share cameras to capture images to ensure quality and video redundancy of the invisibility via exchanging video streams 104. The invention can have methods to ensure multiple connections between different UE to create video stream instances 104, such as Wi-Fi, Ethernet, Bluetooth, ISP Telcom, and other wired/wireless technologies to ensure redundancy, availability, and quality of services for video exchanges 104. In this example, the multiple UE 101 can 10 GB/s stream video content by Ethernet connection 104 using a mix of converters, USB cords, HDMI cables, Mini-USB, 8-pin adapter, USB cords, and straight-through Ethernet 10BASE-T cables and a smart layer 3 switch with 10 GB/s ports, which can be part of an invisibility portals 108.

FIG. 9 represents a simplified possible schematic embodiment of the invention describing a system implementation of the multiple smart devices UE 101 and a technical network configuration for sharing video image streams 108 between multiple polar-opposite UE 101 to create and illustrate a simplified “See-Through” Effect via video image exchanges 104. The multiple UE 101 are placed back to back to illustrate a side view of the “See-Through” Effect 104. The multiple UE 101 share cameras to capture images to ensure quality and video redundancy of the invisibility and when a UE 101 become disabled or broken, the other UE 101 share video streams to compensate based on the sorting and selection methods and criteria 108 in order to choose which camera's video stream to broadcast to which displays, which is what is referred to as Self-Correcting Video Streams 104. he invention can have methods to ensure multiple connections between different UE to create video stream instances 104, such as Wi-Fi, Ethernet, Bluetooth, ISP Telcom, and other wired/wireless technologies to ensure redundancy, availability, and quality of services for video exchanges 104. In this example, the multiple UE 101 can 10 GB/s stream video content by Ethernet connection 104 using a mix of converters, USB cords, HDMI cables, Mini-USB, 8-pin adapter, USB cords, and straight-through Ethernet 10BASE-T cables and a smart layer 3 switch with 10 GB/s ports, which can be part of an invisibility portals 108. This configuration shows the VLANs with a variety of direct lines with Administrative Distances of 0, which upon damage, a new route and thus a new VLAN would be chosen to assist the methods of Self-Correcting Video Streams 104.

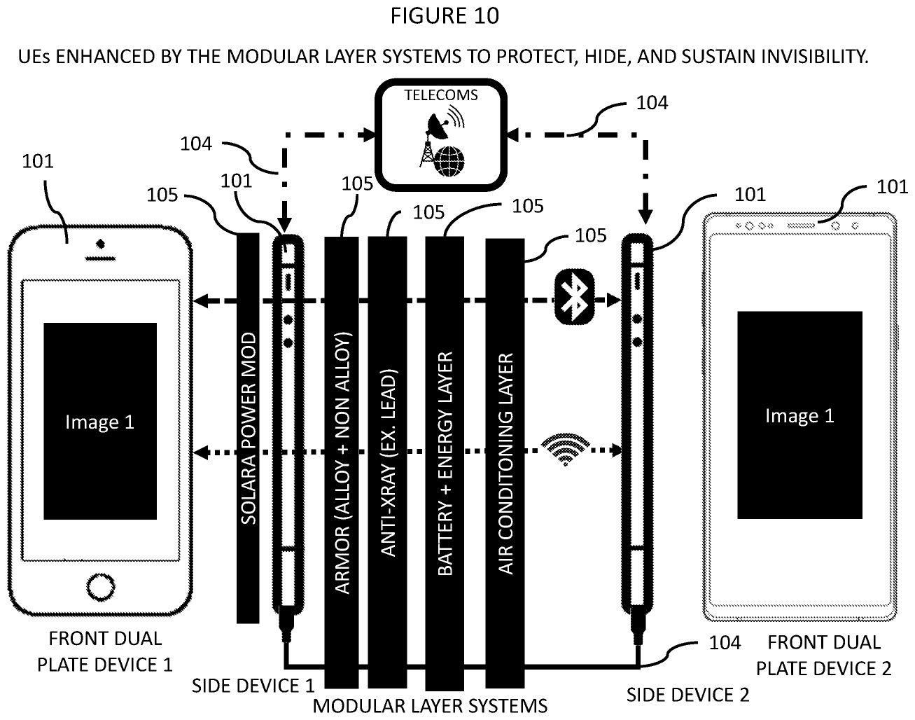

FIG. 10 represents a simplified possible schematic embodiment of the invention describing a system implementation of the two smart devices UE 101 sandwiched between Modular Layer Systems 105 and sharing same images and video streams 104 between with two other two polar-opposite UE 101 to create duplication and quickly support “See-Through” Effect exchanges 104 if the external facing UE 101 inoperable. The two UE are placed back to back to illustrate a side view of the “See-Through” Effect while equipped with modular layer systems 105 supporting the UE 101. Unlike FIG. 6 and FIG. 7, this dual variant can unify two UE 101 to be a single unit for “poke-oke” redundancy if the user installed the UE 101 incorrectly; or one side of dual UE's 101 display is damaged, the dual UE 101 can be flipped as a quick replacement. The invention can have methods to ensure multiple connections between different UE 101 to create video stream mediums, such as Wi-Fi, Ethernet, Bluetooth, ISP Telcom, and other wired/wireless technologies to ensure redundancy, availability, and quality of services for image exchanges 104. This dual UE 101 example, the modular layer system 105 can consist of an armor layer, which can be alloys, non-alloys, and/or a combination of both. Another layer can consist of a slap of metallic lead to stop any x-rays. Another layer can consist of the battery energy layer where batteries, solar-power panels, wireless charging units, and/or other energy battery technology can be implemented. An Air Conditioning Layer can be added if thermal neutralizing is needed and/or cooling the user and/or craft. The layers can be changed and added accordingly. Ideally, these layers 105 should be able to be installed, configured, and reconfigured by the User 106 with ease.

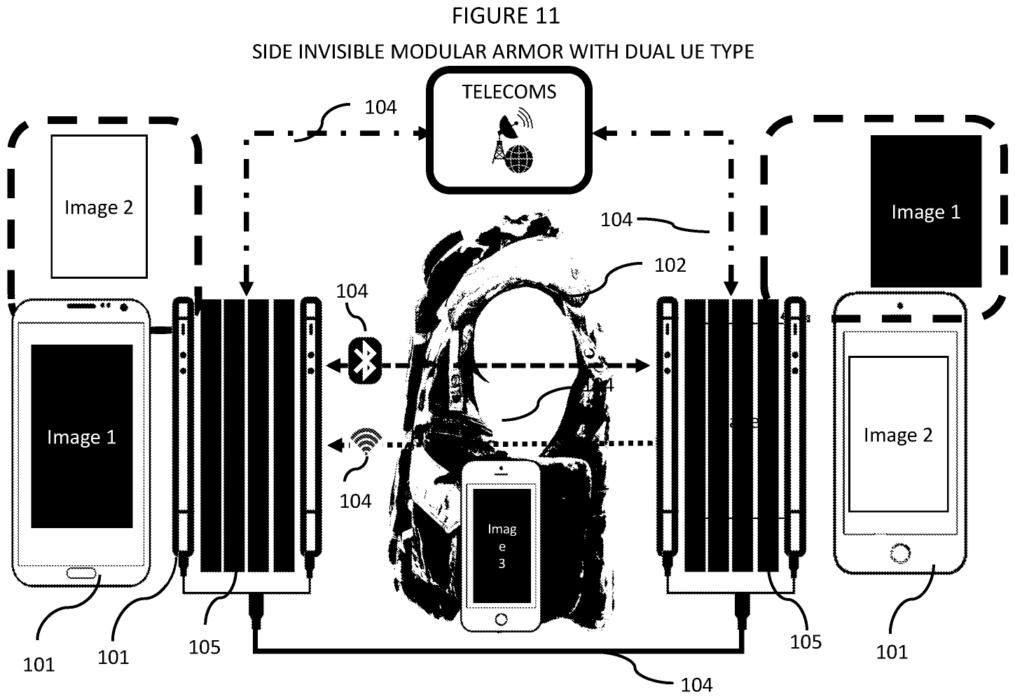

FIG. 11 represents a simplified possible schematic embodiment of the invention describing the methods, system, and apparatus for invisible body modular armor 102 type, which consist of the multiple dual UE 101 meshed on a heavy body armor variant. In this heavy armor variant, all dual UE 101 with Modular Layer System 105 are connected and transmitting video streams 104 to the polar-opposite UE 101 in order to create a “See-Through” effect. The invention can have methods to correct camera problems 104, such as damages. This correction allows the other UE 101 to send and collect the video stream from other UE 101 and pick the best video to stream 104; and/or create a new image based on the images from other cameras when several cameras from those UE 101 share and process the best video stream to be transmitted based on the logic and methods in the invisibility portals 108. The invisible modular armor types can consist of different UE 101 types and it is assumed that the UE 101 can be a combination of generic commercial devices, custom commercial devices, smart e-wearables, and/or military-grade devices.

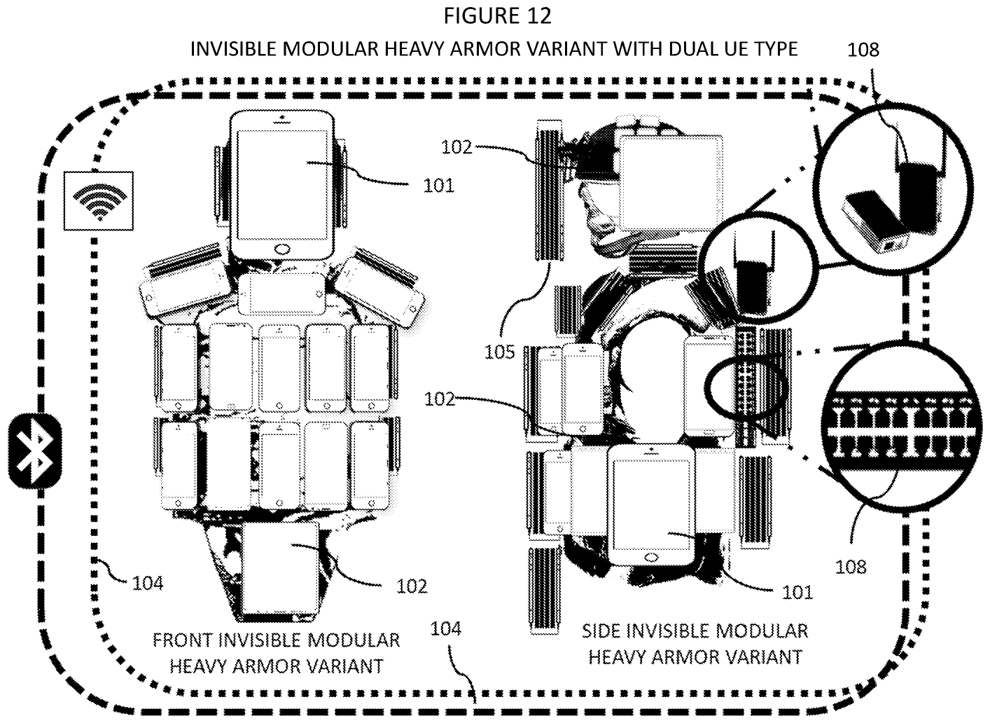

FIG. 12 represents a simplified possible schematic embodiment of the invention describing the methods, system, and apparatus for an invisible body modular armor 102 type, which consist of the multiple dual UE 101 meshed on a heavy body armor with groin protection, an invisible heavy Kevlar helmet 102 variant, and network equipment to create a 100% mobile network 108 making it independent of Telcom communications. In this heavy armor variant, all dual UE 101 with Modular Layer System 105 are connected transmitting video streams to the polar-opposite UE 101 in order to create a “See-Through” effect 104. The invention can have methods to correct camera problems 104, such as damages. This correction allows the other UE 101 to send and collect the video stream from other UE 101 and pick the best video to stream 104; and/or create a new image based on the images from other cameras when several cameras from those UE 101 share and process the best video stream to be transmitted based on the logic and methods in the invisibility portals 108. In this example, the invisible body is equipped with a layer 3 switch and Wi-Fi transmitters to create a more independent mobile network. The invisible modular armor types can consist of different UE 101 types and it is assumed that the UE 101 can be a combination of generic commercial devices, custom commercial devices, e-wearables, and/or military-grade devices.

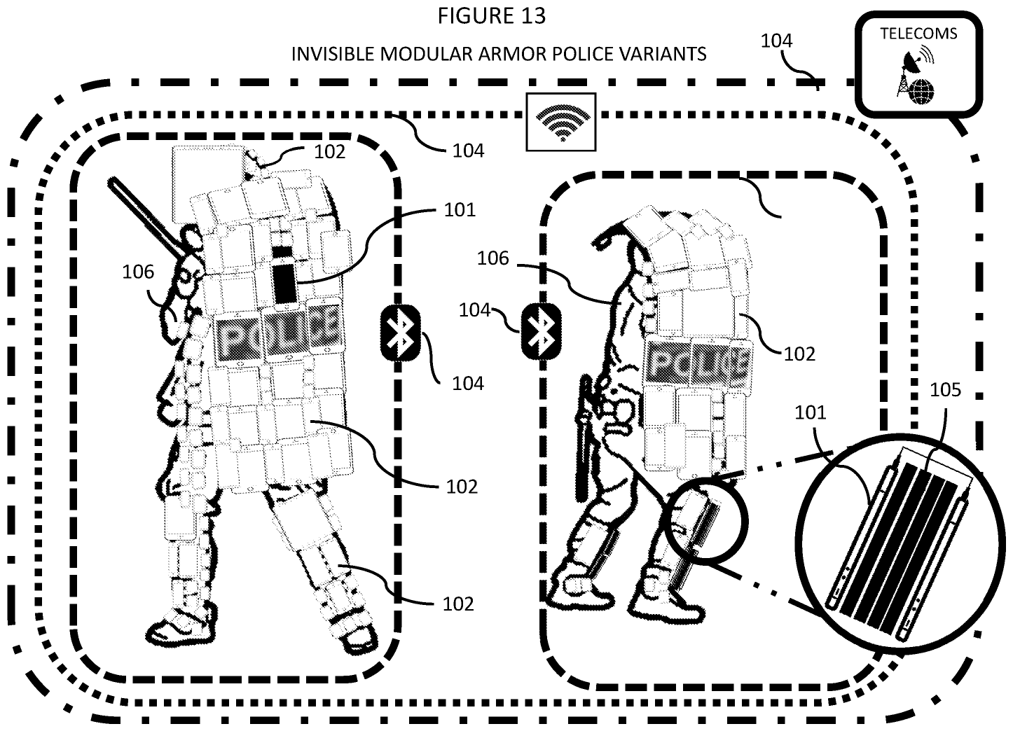

FIG. 13 represents a simplified possible schematic embodiment of the invention describing the methods, system, and apparatus for an invisible personal body modular armor 102 types with modular invisible shields, which consist of the multiple dual UE 101 meshed on a police body armor with groin protection. In this police armor variant, a mix of dual UE 101 with Modular Layer System 105 and single UE 101 are connected and configured to transmit video streams to the polar-opposite UE 101 in order to create a “See-Through” effect 104 and broadcast messages. The invention can have methods to correct camera problems, such as damages. This correction allows the other UE 101 to send and collect the video stream from other UE 101 and pick the best video to stream 104; and/or create a new image based on the images from other cameras when several cameras from those UEs 101 share and process the best video stream to be transmitted. The UE 101 display can also project messages upon the displays of the UE 101 to inform crowds. The invisible modular armor 102 types can consist of different UE 101 types and it is assumed that the UE 101 can be a combination of generic commercial smart devices, custom commercial devices, and/or smart military-grade devices. This FIGURE focuses more on illustrating the use of generic modular UE 101 to create hasty invisible modular shields 102.

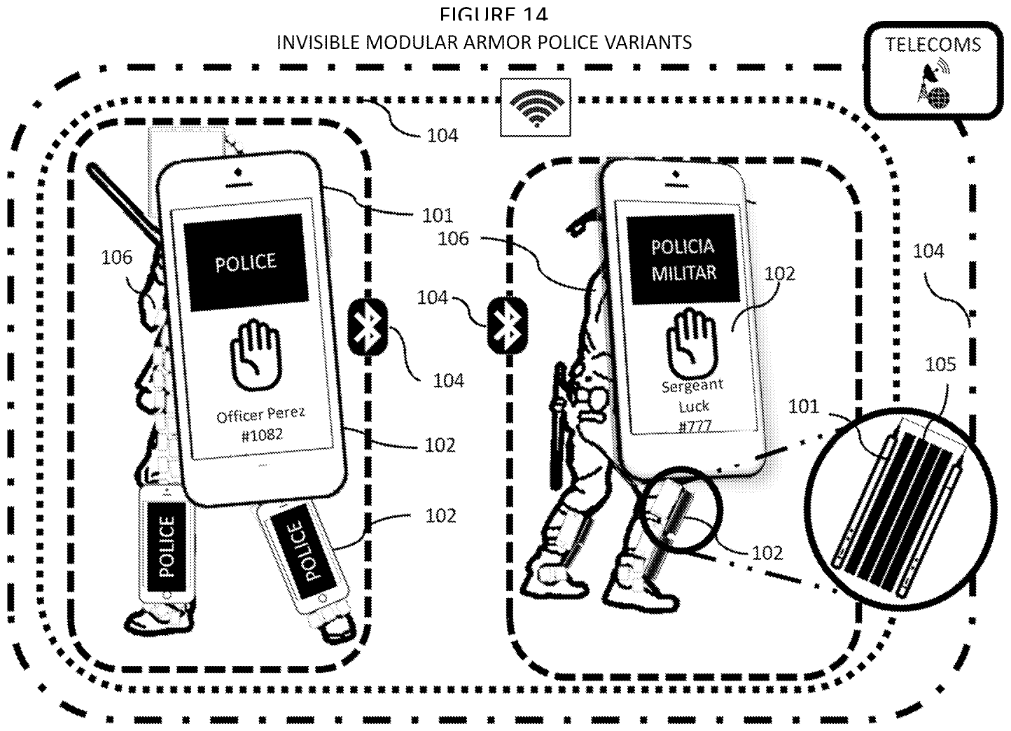

FIG. 14 represents a simplified possible schematic embodiment of the invention describing the methods, system, and apparatus for an invisible personal body modular armor 102 types with custom invisible shields 102, which consist of the multiple dual UE 101 meshed on a police body armor with groin protection. In this police armor variant, a mix of dual UE 101 with Modular Layer System 105 and single UE 101 are connected and configured to transmit video streams to the polar-opposite UE 101 in order to create a “See-Through” effect 104. The invention can have methods to correct camera problems, such as damages. This correction allows the other UE 101 to send and collect the video stream 101 from other UE 101 and pick the best video to stream 104; and/or create a new image based on the images from other cameras when several cameras from those UEs 101 share and process the best video stream 104 to be transmitted. The UE's 101 display can project messages upon the displays of the UE 101. The invisible modular armor 102 types can consist of different UE 101 types and it is assumed that the UE 101 can be a combination of generic commercial devices, custom commercial devices, and/or military-grade devices. This FIGURE focuses more on illustrating the use of custom UE 101 to mix with generic UE 101 to create invisible modular body armor 102 types.

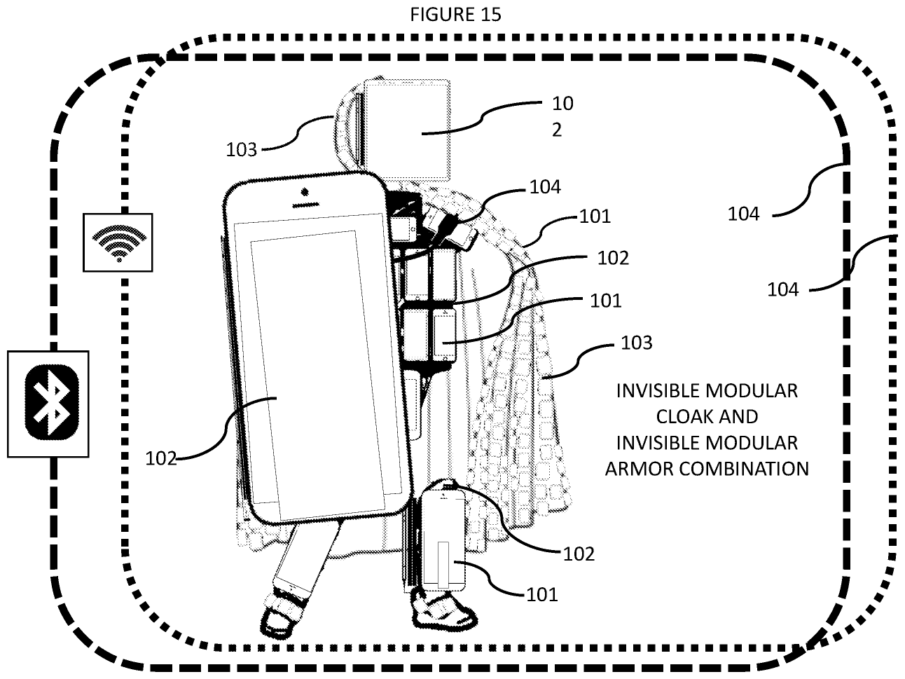

FIG. 15 represents a simplified possible schematic embodiment of the invention describing the methods, system, and apparatus for mix combination of invisible personal body modular armor 102 type and invisible personal modular cloak 103 type, which consist of the multiple UE 101 and dual UE 101 meshed to around a protective blanket netting, a heavy body armor variant, a custom invisible shield 102, and an invisible medium Kevlar helmet 102 variant. All UE 101 are connected transmitting video streams 104 to the polar-opposite devices in order to create a “See-Through” effect. The invention can have methods to ensure multiple connections between different UE 101 to create video stream instances 104, such as Wi-Fi, Ethernet, Bluetooth, ISP Telcom, and other wired/wireless technologies to ensure redundancy, availability, and quality of services for video exchanges 104. The combination can consist of different UE 101 types and it is assumed that the UE 101 can be a combination of generic commercial smart e-wearables, custom commercial devices, and/or military-grade devices.

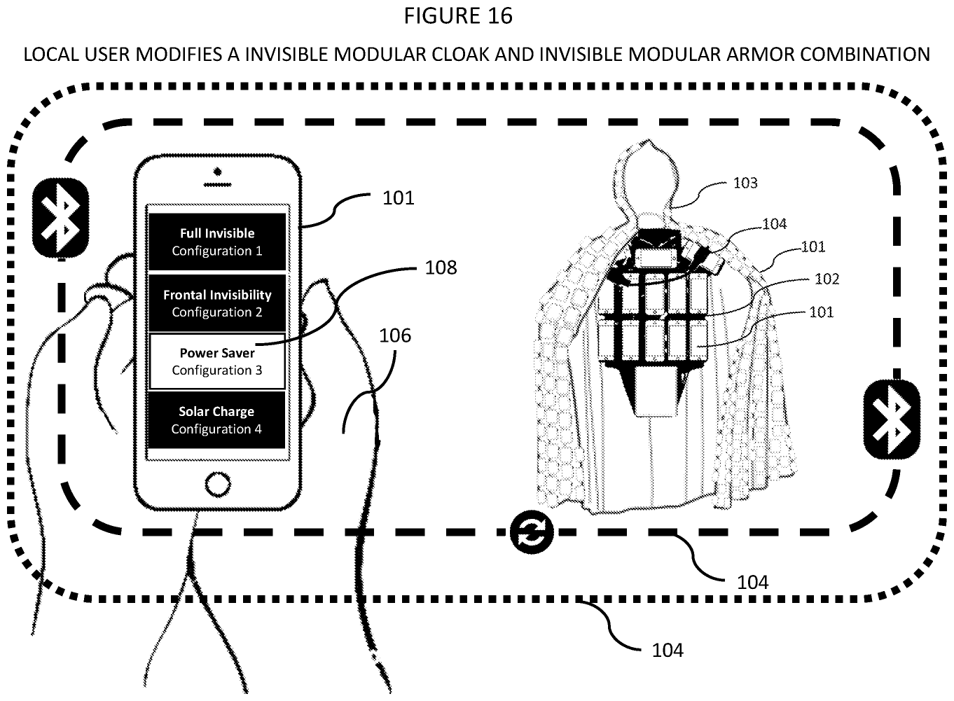

FIG. 16 represents a simplified possible schematic embodiment of the invention describing the methods, system, and apparatus for mix combination of invisible personal body modular armor 102 type and invisible personal modular cloak 103 type, which consist of the multiple UE 101 and dual UE 101 meshed to around a protective blanket netting and a heavy body armor 101 variant. In this case, the user can use an UE 101 (or any, ideally) to configure the user's invisible armor and invisible cloak combination. A mix of single UE 10, dual UE 101, e-wearable UE 101 are connected transmitting video streams 104 to the polar-opposite devices in order to create a “See-Through” effect. The User 106 can utilize a limited version of the invisibility portal 108. From that menu, the User 106 can select a Power Saving mode could reduce or stop the transmissions between UE 101 in the configurations to save power and battery based on a “1-click/2-click” button. Or the User 106 could choose “Full Invisibility” mode to command all UE 101 types and mixes to harmonize and synch their respective UE 101 cameras, produce additional video stream instances with each UE 101, and share cameras between the UE 101. Besides a simple GUI to perform these and more commands, the User 106 can execute Voice and Motion commands to a UE 101 configuration, in this example, a command for both the invisible modular body armor and the invisible modular cloak 103, but such commands may not be ideal in stealth operations, where stillness and silence is critical. The invention can have methods to ensure multiple connections between different UE 101 to create video stream instances 104, such as Wi-Fi, Ethernet, Bluetooth, ISP Telcom, and other wired/wireless technologies to ensure redundancy, availability, and quality of services for video exchanges 104. The invisibility cloaks 103 and invisibility armors can consist of different UE 101 types and it is assumed that the UE 101 can be a combination of generic commercial devices, custom commercial e-wearables, and/or military-grade devices.

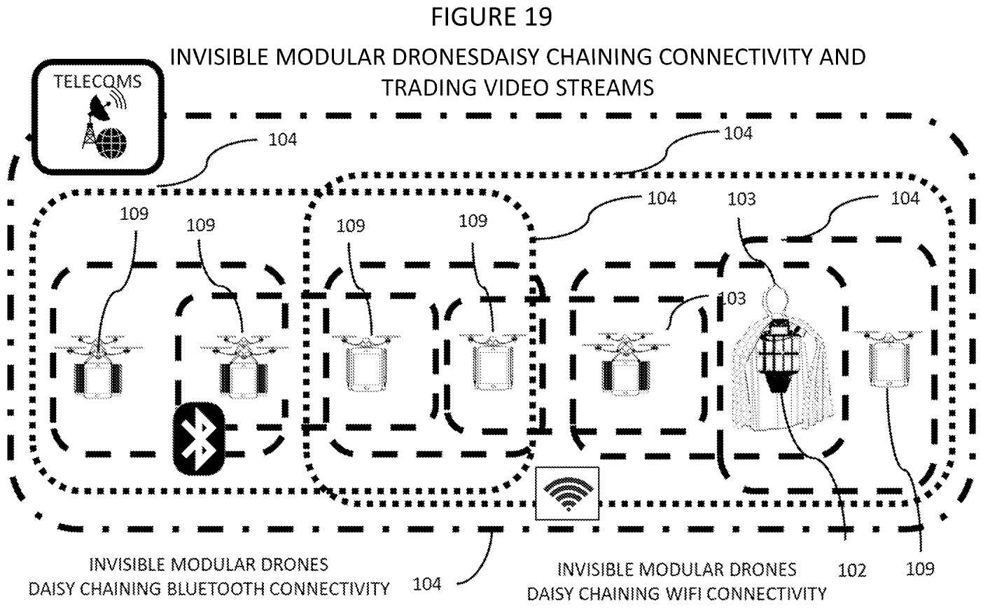

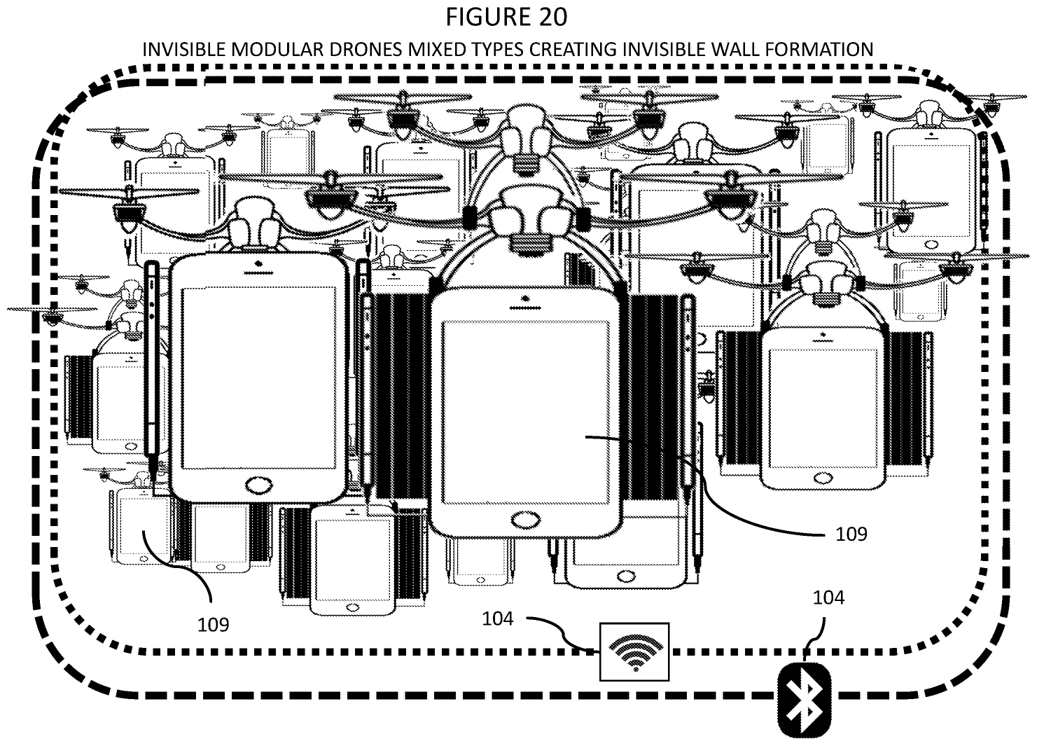

FIG. 17 represents a simplified possible schematic embodiment of the invention describing the methods, system, and apparatus for software administration portal to mix combination of invisible personal body modular armor 102 type, UE 101, groups, Users 106, invisible personal modular cloak 103 types, invisible vehicular modular armors 110, invisible modular drones 109 (FIG. 18), invisible modular flying walls (FIGS. 19-20), and other UE 101 configurations and/or custom configurations. In this case, any User 106 can grab an UE 101 and quickly become Invisibility Administrator 108 (ex. an iPad from an invisibility modular body armor 102) and now can be an administrator utilizing an UE 101 (or any, ideally) to configure, manage, test, and/or provision all of the combinations mentioned previously to deploy Invisibility Combined Arms (FIGS. 23 and 25). With these portals 108, all configurations can be uniquely grouped and connected to transmit video streams to the polar-opposite devices and thus create a “See-Through” effect 104 in individual scenarios to massive scales movements. In this UPGRADE example, the Administrator can apply an upgrade and provision a new Invisibility Helmet variant 102 on a User 106 quickly and easily with simple UI commands. Voice and motion commands could be used, but not ideal in tactical environments. Or the user could choose “Full Invisibility” mode to command all UE 101 types and mixes to harmonize and synch their respective UE 101 cameras. The invention can have methods to ensure multiple connections between different UE 101 to create video stream instances 104, such as Wi-Fi, Ethernet, Bluetooth, ISP Telcom, and other wired/wireless technologies to ensure redundancy, availability, and quality of services for video exchanges 104. The hardware of invisibility portals 108 can consist of different UE 101 types and it is assumed that the UE 101 can be a combination of generic commercial devices, custom commercial smart e-wearables, and/or military-grade devices.

FIG. 18 represents a simplified possible schematic embodiment of the invention describing the methods, system, and apparatus for mix combination of invisible modular flying drone 109 types, both light and heavy styles. These flying drones 109 are equipped with UE 101 types. A mix of single UE 101 and dual UE 101 are connected and transmitting video streams to the polar-opposite devices in order to create a “See-Through” effect 104. The invention can have methods to ensure multiple connections between different UE 101 to create video stream instances 104, such as Wi-Fi, Ethernet, Bluetooth, ISP Telcom, and other wired/wireless technologies to ensure redundancy, availability, and quality of services for video exchanges 104. The combination can consist of different UE 101 types and it is assumed that the UE 101 can be a combination of generic commercial devices, custom commercial devices, and/or military-grade devices. The invisibility modular drone 109 can be controlled by a local User 106, invisibility administrator 107, a remote user, auto-programmed, and/or connected to a swarm technology software managed via a local Invisibility Portal 108. Besides a simple GUI, Voice and Motion commands could be used by User 106 and/or Administrator 107 on the invisible flying modular drones 109, but not ideal in tactical environments.

FIG. 19 represents a simplified possible schematic embodiment of the invention describing the methods, system, and apparatus for multiple combinations of invisible modular flying drone 109 types, both light and heavy style, and an mix of invisible body armor 102 and cloak type 103. These flying drones are equipped with UE 101 types. The mix of UEs 101 are connected transmitting video streams 104 to the polar-opposite devices in order to create a “See-Through” effect. In this example, the invisible modular flying drone 109 types use the invention and methods daisy chain communications to ensure multiple connections between different UE 101 to create multiple video streams, such as Wi-Fi, Ethernet, Bluetooth, ISP Telcom, and other wired/wireless technologies to ensure redundancy, availability, and quality of services for image exchanges. The combination can consist of different UE 101 types and it is assumed that the UE 101 can be a combination of generic commercial devices, custom commercial devices, and/or military-grade devices. the invisibility modular drones 109 can be controlled by a local User 106, invisibility administrator 107, a remote user, auto-programmed, and/or connected to a swarm technology software managed via a local Invisibility Portal 108. The illustration focuses on stretching the formations and still retain connectivity between all UE 101, which is a type of Invisibility Combined Arms Actions 111 by spreading the line. Besides a simple GUI, Voice and Motion commands could be used by User 106 and Administrator 107 on the invisible flying modular drones, but not ideal in tactical environments.

FIG. 20 represents a simplified possible schematic embodiment of the invention describing the methods, system, and apparatus for massive combinations of invisible modular flying drone 109 types, both light and heavy styles in order to create a flying invisibility wall 111 that quickly protect and hide whatever is behind them. These invisible flying drones 109 are equipped with UE 101 types. All UE 101 are connected transmitting video streams to the polar-opposite devices in order to create a “See-Through” effect 104. In this example, the invisible modular flying drone 109 types use the invention and methods to daisy chain communications to ensure multiple connections and synchronization between different UE to create multiple video streams instances via Wi-Fi, Ethernet, Bluetooth, ISP Telcom, and other wired/wireless technologies to ensure redundancy, availability, and quality of services for image exchanges 104. The combination can consist of different UE 101 types and it is assumed that the UE 101 can be a combination of generic commercial devices, custom commercial devices, and/or military-grade devices. The invisibility modular drone 109 can be controlled by a local User 106, invisibility administrator 107, an remote user, auto-programmed, and/or connected to a swarm technology software managed via a local and/or remote Invisibility Portal 108. The illustration focuses on stretching the formations and still retain connectivity between all UE. Besides a simple GUI, Voice and Motion commands could be used by User 106 and Administrator 107 on the invisible flying modular drones, but not ideal in tactical environments. The buzzing sounds of thousands of flying invisible drones 109 can prompt the User 106 and/or the Invisibility Administrator 107 to enter the portal 108 to coordinate all the UE 101 to implement Noise Reduction Controls and reduce the noise levels.

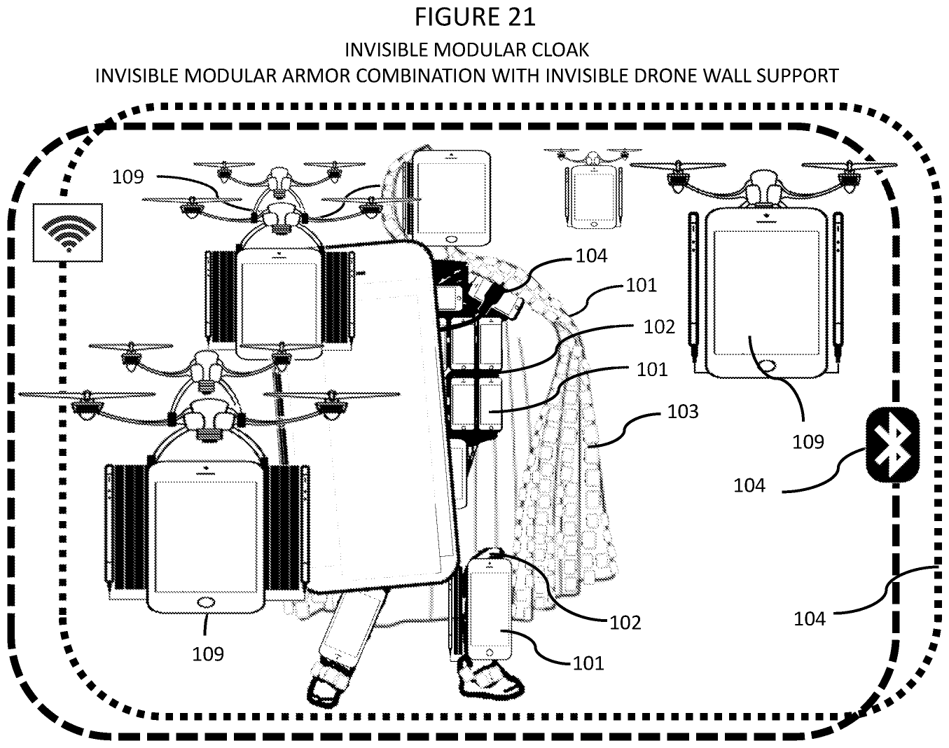

FIG. 21 represents a simplified possible schematic embodiment of the invention describing the methods, system, and apparatus for a massive combinations of invisible modular flying drone 109 types, both light and heavy style, and a invisible modular armor 102 and invisible cloak 103 mix in order to create a flying invisibility personal wall 111 (at least, for additional protection) that quickly protects and hide the User 106. These invisible flying drones 109 are equipped with UE 101 types. The UE 101 are connected transmitting video streams 104 to the polar-opposite devices in order to create a “See-Through” effect. Besides protection, the User 106 can order the invisible modular flying drone 109 types to scout in front of the User 106 for safety and reduce exposure. The invisible modular flying drone 109 types use the invention and methods daisy chain communications to ensure multiple connections between different UE 101 to create mediums, such as Wi-Fi, Ethernet, Bluetooth, ISP Telcom, and other wired/wireless technologies to ensure redundancy, availability, and quality of services for video stream exchanges 104. The combination can consist of different UE 101 types and it is assumed that the UE 101 can be a combination of generic commercial devices, custom commercial devices, and/or military-grade devices. The User 106 can be a local user 106, a remote user 106, auto-programmed, and/or connected to a swarm technology software based on the invisibility portal's 108 settings. The illustration focuses on stretching the formations 111 and still retain connectivity between all UE 101. Besides a simple GUI, Voice and Motion commands could be used by User 106 and Invisibility Administrator 107 on the invisible flying modular drones 109, but not ideal in tactical environments. In such massive formations, the buzzing sounds of thousands of invisible flying drones 109 would be obvious to human ears. Thus, for tactical reasons, Active noise control (ANC) technologies, also known as noise cancellation, or active noise reduction (ANR) will likely be required to reduced unwanted sound by the addition of a second sound specifically designed to cancel the first via one or many UE 101. Sound is a pressure wave, consisting of alternating periods of compression and rarefaction, which can be countered with the UE's 101 speakers, the UE's 101 voice receivers, and/or other enhancements with the combination.

FIG. 22 represents a simplified possible schematic embodiment of the invention describing the methods, system, and apparatus for an invisible modular craft light armor type, which can consist of a multiple and mixed single UE 101 and dual UE 101 meshed on a helicopter. In this light armor variant, all variants of UE 101 with Modular Layer System 105 are connected transmitting video streams 104 to the polar-opposite devices in order to create a “See-Through” effect 104. In this case, this invisible modular craft light armor 110 type should attempt to hide and/or reduce the visual exposure of the helicopter. In addition, due to the nature of sharing cameras between UE 101, developers with administration access 107 can link this feature to the defense and attack systems of any craft, in this example, a helicopters' defense flare and a targeting system. Some API can be added to the administration portals 108 for such enhancement. However, the focus of the invention is invisibility, protection, and stealth; thus, additional features are optional. The invention can have methods to correct camera problems, such as the damages of UE 101. This correction allows the other devices to send and collect the video stream 104 from other devices and pick the best video to stream 104; and/or create a new image based on the images from other cameras when several cameras from those UEs 101 share and process the best video stream to be transmitted. This system of video image correction 104 will be critical in the case of fast-moving crafts, such as helicopters, airplanes, spacecraft, etc. . . . . These problems are more prevent in Telcom2Telcom video streaming, which can be UE sending video stream to ISP 1 tower, ISP 1 tower to ISP 1 data center via Fiber, then to the next ISP 1 data center via Fiber to ISP 2 data center via Fiber, ISP 2 data center to ISP 2 tower, and finally, ISP 2 tower to second UE 101. Whereas a UE 101 can send a signal to another UE 101 via Wi-Fi and/or Bluetooth reducing the data hops. For that very reason, variants of the invention likely to require multiple methods to ensure multiple connections between different UE 101 to create mediums, such as Wi-Fi, Ethernet, Bluetooth, ISP Telcom, and other wired/wireless technologies to ensure redundancy, availability, and quality of services for image exchanges 104. The invisible modular craft armor 110 types can consist of different UE 101 types and it is assumed that the UE 101 can be a combination of generic commercial devices, custom commercial devices, e-wearables, microdevices, and/or military-grade devices. Nanobots can be part of the UE 101 scope, but Nanotechnology is currently in its infancy and thus reducing the chances of fusing with the science of invisibility in the next 10 to 30 years.

FIG. 23 represents a simplified possible schematic embodiment of the invention describing the methods, system, and apparatus for an invisible modular craft light armor 102 type, which can consist of a multiple and mixed single UE 101 and dual UE 101 meshed on a helicopter; and a wall of invisible flying drones 109 in a protective formation around the helicopter. In this light armor 102 variant, all variants of UE 101 with Modular Layer System 105 are connected and configured to transmit video streams 104 to the polar-opposite devices in order to create a “See-Through” effect. In this case, this invisible modular craft light armor 110 type should attempt to hide or reduce the visual exposure of the helicopter; while the invisible flying drones wall formations 111 should provide additional protection and features around the helicopters. Due to the discrepancy of helicopter turbine power versus simple drone 109 propellers, the invisible flying wall formations 111 of invisible modular drones 109 will likely be implemented as invisible defensive postures 111; slow invisible infantry support 111; and/or invisible helicopter take-offs 111 and arrivals to helipads to hide and/or protect the helicopters during hovering exposure 111, but with enough distance to stop any UE 101 from become safety hazard to the helicopter and the crew. Such safety enhancements can be programmed 108. In addition, due to the nature of sharing cameras between UE 101, developers with administration access 107 can link this feature to the defense and attack systems of any craft, in this example, a helicopters' defense flying wall defenses and a counter anti-missile defense system. Some API can be added to the administration portals 108 for such enhancement. The invention can have methods to correct camera problems, such as damages. This correction allows the other devices to send and collect the video stream 104 from other devices and pick the best video to stream 104; and/or create a new image based on the images from other cameras when several cameras from those UEs 101 share and process the best video stream to be transmitted. This system 108 of video image correction 104 will be critical in a case of fast-moving crafts, such as helicopters, airplanes, spacecraft, etc. . . . . These problems are more obvious in Telcom2Telcom video streaming 104, which can be an UE 101 sending video stream to ISP 1 tower, ISP 1 tower to ISP 1 data center via Fiber, then to the next ISP 1 data center via Fiber to ISP 2 data center via Fiber, ISP 2 data center to ISP 2 tower, and finally, ISP 2 tower to second UE 101. In contrast in time and distance savings, a UE 101 can send a signal to another UE 101 via Wi-Fi and/or Bluetooth and reducing the data hops for the video exchanges 104. For that very reason, variants of the invention likely to require multiple methods to ensure multiple connections between different UE 101 to create mediums, such as Wi-Fi, Ethernet, Bluetooth, ISP Telcom, and other wired/wireless technologies to ensure redundancy, availability, and quality of services for video stream instances exchanges 104. The invisible modular craft armor 110 types can consist of different UE 101 types and it is assumed that the UE 101 can be a combination of generic commercial devices, custom commercial devices, smart e-wearables, and/or military-grade devices.

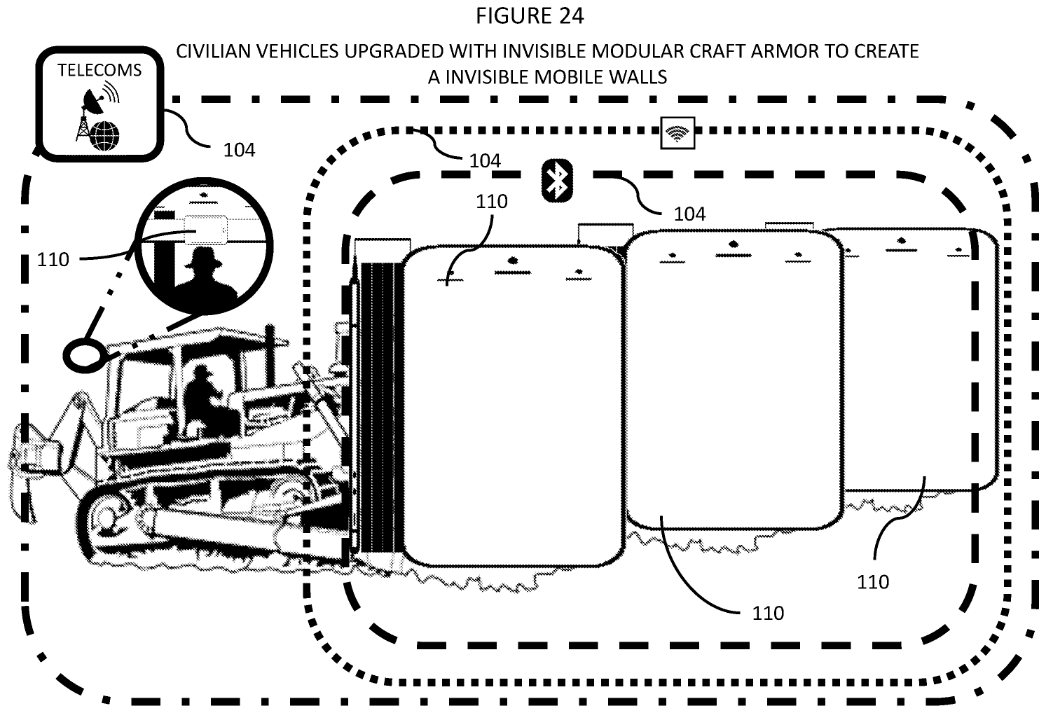

FIG. 24 represents a simplified possible schematic embodiment of the invention describing the methods, system, and apparatus for invisible modular craft armor 110 types modified to civilian tractor vehicles to form invisible mobile wall formations 111, which consist of mounting multiple large custom heavy variant dual UE 101. All UE 101 are connected transmitting video streams 104 to the polar-opposite devices in order to create a “See-Through” effect. In this case, UE attached on the back of the civilian tractor cab has been configured to exchange signals with the invisible modular craft type 110 mounted. The invention can have methods to ensure multiple connections between different UE 101 to create video streams exchanges, such as Wi-Fi, Ethernet, Bluetooth, ISP Telcom, and other wired/wireless technologies to ensure redundancy, availability, and quality of services for those video instances. The combination can consist of different UE 101 types and it is assumed that the UE 101 can be a combination of generic commercial devices, custom commercial devices, and/or military-grade devices. This example focuses on mixing the modularity and custom types to mobilize civilian transports and civilian machinery for civic defense efforts. Such civilian vehicle mobilization can be used as quick fortifications of areas of operations and to build simple invisible city walls to hide and protect civilian populations from the rage of war. Or for “Civilian-Friendly” purposes only, the mobile wall formations can be configured and placed to create quick music concert hall and switch the displays from “See-Through” invisibility to fun psychedelic images for the crowds to enjoy.

FIG. 25 represents a simplified possible schematic embodiment of the invention describing the methods, system, and apparatus for mix combination of invisible personal body modular armor 102 types, invisible module craft armor 110 types, and invisible personal modular cloak 103 type, invisible modular flying drones 109 variants, and other invisible configuration deployments which consist of the multiple UE 101 and dual UE 101 meshed to around a protective blanket netting, a body armor 102 variants, a custom invisible shield 102, invisibility drones 109, an invisible medium Kevlar helmet 102 variants, helicopters, and more. All UE 101 type are connected and transmitting video streams to the polar-opposite devices in order to create a “See-Through” effect 104. The invention can have methods to ensure multiple connections between different UE 101 to create mediums, such as Wi-Fi, Ethernet, Bluetooth, ISP Telcom, and other wired/wireless technologies to ensure redundancy, availability, and quality of services for video streams exchanges 104. In this case, all the different invisibility configurations should enable any unit level commander to perform Invisibly Combined Arms 111 to support infantry advancements via the help of an admin portal 108. The combination can consist of different UE 101 types and it is assumed that the UE 101 can be a combination of generic commercial devices, custom commercial devices, and/or military-grade devices. In such massive formations, the buzzing sounds of thousands of invisible flying drones 109, helicopter turbines, loud civilian tractors, and/or human military moment would be obvious to human ears. Thus, for tactical reasons, Active noise control (ANC) technologies, also known as noise cancellation, or active noise reduction (ANR) will likely be required to reduced unwanted sound by the addition of a second sound specifically designed to cancel the first. Sounds are pressure waves, consisting of alternating periods of compression and rarefaction, which can be countered with the UE's 101 speakers, the UE's 101 voice receivers, and/or other enhancements.

FIG. 26 represents a simplified possible schematic embodiment of the invention describing the methods, system, and apparatus for mix combination of invisible modular body armor 102, invisibility cloaks 103, and an invisibility modular drones 109 in an Invisible Hyper-Modular format where the UE 101 are miniaturized by technological advancements and manage via an embodiment of the invisibility portal 108 with MoM HCS-style module to handles millions of endpoints and video streams exchanges 104 supported by multiple broadcast channels from Bluetooth, Wi-Fi, Telecoms, Ethernet mods, and more.

FIG. 27 represents a simplified possible schematic workflow of the invention describing the methods, system, and apparatus for interactions between the software administration portal 108, the Admin 17, and a mixed configuration within a deployment. This configuration view shows an invisible personal body modular armor 102, UE 101, a group (ex. a deployment of configurations), Users 106 (in this case, an an Admin 107 as a User 106), video stream exchange reconfiguration 104 and other UE 101 configurations and/or custom configurations based on criteria, logic conditions, sorting actions, port switching between video streams, and quality testing within the portal's 108 environment and the respective UE 101. In this case, any User 106 can grab a UE 101 and quickly become Invisibility Administrator 108 (ex. an iPad from an invisibility modular body armor 102); and now utilizing a UE 101 (or any, ideally) to update the Criteria 1 (ex. Pixelation Table). With these portals 108, all configurations can be uniquely grouped and connected to transmit video streams 104 to the polar-opposite devices and thus create a “See-Through” effect 104 in individual scenarios to massive scales movements. In this CRITERIA example, the Administrator 107 can apply an upgrade and provision a new rule to execute a change in video streams port 104 based on administrative distance and pixelation tables 108. The hardware of invisibility portals 108 can consist of different UE 101 types and it is assumed that the UE 101 can be a combination of generic commercial devices, custom commercial smart e-wearables, and/or military-grade devices.

Embodiments of the present invention may be implemented in software 108, hardware, application logic or a combination of invisibility software 108, hardware 101 and application logic 108. The software, application logic and/or hardware 108 may reside on a user's 106 UE 101 (ex. iPhone), segregated servers from the data lakes, in the data lake environments, in the hosted environments (ex. AWS, Azure, Shopify), in the Telcom environments, and/or distributed in a P2P network 104 with or without blockchain technology enhancements. If desired, part of the invisibility software 108, application logic 108 and/or hardware 101 may reside on a user's 106 UE 101 (ex. iPhone), segregated servers from the data lakes, in the data lake environments, in the hosted environments (ex. AWS, Azure, Shopify), in the Telcom environments, and/or distributed in a P2P network 104 with or without blockchain technology enhancement. In an example embodiment, the application logic 108, software 108 or an instruction 108 set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with few examples of a computer described and depicted in FIG. 1-27. A computer-readable medium may comprise a computer-readable storage medium that may be any media or means that can contain or store the instructions for use by or in connection with an instruction execution system, apparatus, or device, such as a computer.

There are two main kinds of semiconductor memory, volatile and non-volatile. Examples of non-volatile memory are flash memory (used as secondary memory) and ROM, PROM, EPROM and EEPROM memory (used for storing firmware such as BIOS). Examples of volatile memory are primary storage, which is typically dynamic random-access memory (DRAM), and fast CPU cache memory, which is typically static random-access memory (SRAM) that is fast but energy-consuming, offering lower memory areal density than DRAM.

Non-volatile memory is computer memory that can retain the stored information even when not powered. Examples of non-volatile memory include read-only memory (see ROM), flash memory, most types of magnetic computer storage devices (e.g. hard disk drives, floppy disks, SSD, NVMe M.2, and magnetic tape), optical discs, and early computer storage methods such as paper tape and punched cards. Non-volatile memory technologies may include FeRAM, CBRAM, PRAM, STT-RAM, SONOS, RRAM, racetrack memory, NRAM, 3D XPoint, and millipede memory.

The present invention consisting of a method, system, and apparatus to manage invisibility groups is enabled by computer instructions stored on non-volatile memories.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

A plurality shall mean one or more.

It is also noted herein that while the above describes example embodiments of the invention, these descriptions should not be viewed in a limiting sense. There are several variations and modifications which may be made without departing from the scope of the present invention as defined in the appended claims.

What is claimed is:

1. Method of multi-use multi-vision modular invisible covers comprising of:
aggregating a plurality of displays, cameras, and/or devices into physical meshes and virtual networks where the cameras, displays, and/or devices exchange data transactions from multiple sources and transmissions between meshed cameras, displays, and/or devices to project on their respective screens the exchanged images, videos, and/or visual adjustments to produce multiple video stream “See-Through” effects between meshed cameras, displays, and/or devices;
live “See-Through” video streams and/or previously recoded See-Through” video streams that adjust, re-adjust, and/or compensate within any invisibility configuration between the meshed cameras, displays, and/or devices as those displays, cameras, and/or devices move, reform, bend, overlap, twist, turn, travel, spin, rotate, flex, detach, attach, break, damage, swing in opposite directions, and/or change positions;
the ability to create multiple configurations and reconfigurations from the plurality of cameras, displays, and/or devices that create a range of invisible cover permutations such as light invisibility cloaks, invisible personal body armors, invisibility craft armors, invisible camo netting, invisible drones, invisible bunkers, and more per deployment;
the ability to synch any camera, display, and/or device into an invisibility deployment and/or invisibility configuration by remote access, preset set by user/s, manually added locally by user, and/or by auto proximity in order to replace, cannibalize, and/or reinforce any invisibility configuration and/or deployment;

2. A multi-use multi-vision modular invisible covers method of claim 1, wherein the displays, cameras, and/or devices protect the user, craft, entity, building, and/or equipment from harm by reinforcing all or some plurality of cameras, displays, and/or devices with alloys and/or non-alloys elements within any configuration and/or deployment.

3. An multi-use multi-vision modular invisible covers method of claim 1, wherein the displays, cameras, and/or devices with network redundancies of Wi-Fi, Bluetooth, ethernet, micro waves, radio waves, other cabled technology, and/or wireless technologies within the plurality of cameras, displays, and/or devices to ensure self-correcting “See-Through” video streams, multiple camera sharing, quality of service, network availability, and/or correct operator mistakes.

4. A multi-use multi-vision modular invisible covers types method of claim 1, wherein the displays, cameras, and/or devices are enabled to create multiple pre-fabricated “See-Through” video streams ready to replace the previous “See-Through” video stream upon failure, which can be activated individually, tiered, partially, triggered, and/or simultaneously per invisibility configuration per deployment.

5. A multi-use multi-vision modular invisible covers method of claim 1, wherein the displays, cameras, and/or devices are enhanced with the ability to create multiple invisibility configurations from the plurality of cameras, displays, and/or devices ranging from preset forms to “ad hoc” designs to self-learning per deployment.

6. A multi-use multi-vision modular invisible covers method of claim 1, wherein the displays, cameras, and/or devices are reinforced displays, cameras, and/or devices with water-proofing materials and/or covers to handle several ranges of ATM and Ingression Protection in fresh water and salt water, anti-fogging materials and/or covers, weather-proofing materials and/or covers to handle hot desert climates and cold winter climates, and/or outer space-proofing materials and/or covers zero gravity.

7. A multi-use multi-vision modular invisible covers method of claim 1, wherein the displays, cameras, and/or devices are enhanced with the ability to integrate multiple helmets, e-wearables, custom devices, accessories, flexible materials, and/or other equipment to any invisibility configuration.

8. A multi-use multi-vision modular invisible covers method of claim 1, wherein the displays, cameras, and/or devices are enhanced with the ability to connect to external networks and/or peer local networks to improve accuracy, reception, and/or share resources within the invisibility configurations and/or deployments.

9. A multi-use multi-vision modular invisible covers method of claim 1, wherein the displays, cameras, and/or devices are enhanced with video streaming proximity-sharing technology using daisy-chaining methods to ensure “See-Through” video streaming among displays, cameras, and/or devices between and/or across different configurations and/or deployments.

10. A multi-use multi-vision modular invisible covers method of claim 1, wherein the displays, cameras, and/or devices are enhanced multiple settings to provide full invisibility, partial invisibility, solar charging, power saving, pairing, off, and/or other settings per configuration per deployment.

11. A multi-use multi-vision modular invisible covers method of claim 1, wherein the displays, cameras, and/or devices are enhanced command and control mechanisms for the user of any invisibility configuration with multiple commands options including voice commands, motion commands, touch commands, remote commands, and/or GUIs commands.

12. A multi-use multi-vision modular invisible covers method of claim 1, wherein the displays, cameras, and/or devices are enhanced with air conditioning units, pumps, heat sinks, fans, coolants, heaters, thermal pastes, and/or coils in order to match, rise, or reduce the thermal heat signals of user, drone, craft, and/or building to the local environment with any invisibility configuration and/or deployment.

13. A multi-use multi-vision modular invisible covers method of claim 1, wherein the displays, cameras, and/or devices are enhanced with illumination controls that match or reduce the light of local environment, user, drone, and/or craft by enhancing the displays, cameras, and/or devices with light-neutral materials, by absorbing light with the displays, cameras, and/or devices, and/or by adjusting light within the displays, cameras, and/or devices of any configuration and/or deployment.

14. A multi-use multi-vision modular invisible covers method of claim 1, wherein the displays, cameras, and/or devices are enhanced with high density lead alloys and/or other materials that neutralize the x-ray signals and gamma radiations send to any configuration and/or deployment.

15. A multi-use multi-vision modular invisible covers method of claim 1, wherein the displays, cameras, and/or devices are enhanced with power-sharing technology using daisy-chaining powering methods, battery alloy-reinforcements, craft powered, generator powered, and/or solar-power add-ons to any configuration and/or deployment.

16. A multi-use multi-vision modular invisible covers method of claim 1, wherein the displays, cameras, and/or devices are enhanced active noise controls to cancelling or reducing any noises produce by swarms invisible flying drones, vehicles, and/or human sounds produced by any user/s with any invisibility configuration and/or deployments.

17. A multi-use multi-vision modular invisible covers method of claim 1, wherein the displays, cameras, and/or devices are enhanced cancelling or reducing sonar pulses sound waves with active noise controls produce by watercraft equipped with water-proof depth-proof cameras, displays, and/or devices with water-proof depth-proof speakers.

18. A multi-use multi-vision modular invisible covers method of claim 1, wherein the displays, cameras, and/or devices coordinate to project messages, create light flashes to blind the enemy, display colors, show camouflage patterns, and/or distorted images when creating confusing, blending with terrain, and/or creating fear becomes priority, and “See-Through” video streaming is no longer practical.

19. A multi-use multi-vision modular invisible covers method of claim 1, wherein the displays, cameras, and/or devices can operate in decentralized fashion, centralized fashion, and/or a combination both centralized and decentralized fashion within any configuration and/or deployment.

20. A multi-use multi-vision modular invisible covers method of claim 1, wherein any device can be segregated from an invisibility configuration and the user adds flight technology to the segregated device within an invisibility configuration to deploy short-range invisible drone scout.

21. A multi-use multi-vision modular invisible covers method of claim 1, wherein the displays, cameras, and/or devices are added to drones with flight technology that can deployed into flying invisible defensive walls swarm formations and with the ability to combine with any invisibility configuration and/or deployment.

22. A multi-use multi-vision modular invisible covers method of claim 1, wherein the displays, cameras, and/or devices are added to drones with land transportation technology that can be deployed into land invisible defensive walls formations and with the ability to combine with any invisibility configuration and/or deployment.

23. A computer-implemented invisibility software platform portal of data and video exchanging that produces and sustains the multi-use multi-vision modular invisible covers, which;
a) provides a network portal to onboard and provision displays, cameras, devices and/or users into their respective networks, configurations, directories, and/or settings.
b) provides a data exchanging platform for plurality of displays, cameras, and/or devices to manage data, listen and receive, validations, tests, sort, select, triggers, and/or commands within respective networks.
c) provides a video brokering platform for plurality of displays, cameras, and/or devices to trade video streams, data, overlapping video streams, and image adjustment mechanisms.
d) prevents displays, cameras, and/or devices from failure and, upon failure, image compensations by using rules, devices, and mechanisms to test, qualify, combined, and/or correct the video streams.
e) consists of one or more displays, cameras, devices, remote server environments, data lakes, and/or a decentralized P2P network within the invisible device networks.

24. A computer-implemented multi-use multi-vision modular invisible covers method of claim 1, wherein the data and video provided by the displays, cameras, and/or devices is selected and distributed in accordance with standard IT protocols, geo-location tables, proximity tables, pixelation tables, temperature tables, rule algorithms, illumination tables, Administrative Distances, elevation tables, conditions, battery levels, preset filters, error correction controls, workflows, trigger mechanisms, personalized settings, user directories, command settings, and/or an associated meta tags.

25. A computer-implemented multi-use multi-vision modular invisible covers method of claim 1, further including providing “Camera Sharing” management through the video brokering platform to coordinate the device's cameras and displays for image distribution, video stream “See-Through” polarizing methods, video stream overlapping, light reflection distribution, pre-fabricated video instances, light redirection distribution, light abstraction distribution, light flashes, image distortions, visual messages, camera troubleshooting, video replays, and/or other video management methods.

26. A computer-implemented multi-use multi-vision modular invisible covers method of claim 1, further including invisibility deployment triggers methods, which are light-based, time-based, command-based, thermal-based, x-ray based, pixilation-based, battery-based, geofenced-based, sound-based, radar-based, sonar-based, preset-based, illumination-based, and/or data-based through the video brokering platform and/or portals.

27. A computer-implemented multi-use multi-vision modular invisible covers method of claim 1, further including data treatment methods for multiple data sources, which are encryption, encapsulation, decapsulation, block-chain, and/or time-limits.

28. A computer-implemented multi-use multi-vision modular invisible covers method of claim 1, further including storage methods for multiple data sources and delivery methods by multiple wired and/or wireless ports within each invisibility deployment and/or a plurality of devices.

29. A computer-implemented multi-use multi-vision modular invisible covers method of claim 1, further including methods for tracking, managing, and reporting device/s' and user/s' temperatures, heat signals, night vision gamma energy, light absorption, light reflection, enemy positions, light redirection, x-ray interactions, sonar detection, radar detection, and/or noise levels.

30. A computer-implemented multi-use multi-vision modular invisible covers method of claim 1, wherein the manager-of-manager portal platform can provision, manage, and monitor billions of invisible endpoints, devices, cameras, displays, invisible users, invisible vehicles, invisible crafts, invisible cloaks, invisible land drones, invisible flying drones, invisible water drones, invisible camo nettings, and invisible configurations and can be operated by a third-party service provider to offers invisibility deployments using these platforms.
